(19) United States
(12) Patent Application Publication
(10) Pub. No.: US 2012/0304075 A1
(43) Pub. Date: Nov. 29, 2012

(54) SYSTEM AND METHOD FOR MANAGEMENT OF MOTIONS

(76) Inventors: Ross E. Dworkin, Springfield, PA (US); Charles A. Bono, Philadelphia, PA (US)

(21) Appl. No.: 13/113,314

(22) Filed: May 23, 2011

(51) Int. Cl. G06F 15/16; G06F 3/048

(52) U.S. Cl. 715/753

(57) ABSTRACT

An online system allows multiple participants, in geographically diverse locations, to consider and vote upon a motion or other document. The system enables the participants to post questions and comments, and to propose that a motion be broken up into clauses, and to vote both on the proposed manner of breakup of the motion, and on the motion itself. The votes of the participants may be weighted in accordance with rules which are previously set. The participants may vote to link certain clauses, such that linked clauses may be treated in accordance with certain rules to which the participants shall have agreed.

### BACKGROUND OF THE INVENTION

This invention relates to the field of governance, and provides a system and method by which a group of persons, typically found in disparate geographical locations, can collaborate to agree upon motions or rules for governing an entity.

An organization typically must create new rules of conduct for its members, or modify existing rules. At other times, the organization may need to react to a specific circumstance. Rules often begin as motions, which then may progress to ballot initiatives, referendums, propositions, protocols (in the field of medicine), or other binding directives.

The purpose of the system described in this specification is to aid in the transformation of motions into formal policy, through the collaboration of geographically dispersed individuals. The invention may be used by governments, corporations, societies and professional organizations, or other entities.

The present invention has various applications. It may be used for political discourse within a legislative body, or a subset of such body, such as a committee. It may be used in a corporate setting, both for-profit and non-profit, allowing board members to use the present invention prior to, or instead of, face-to-face meetings where corporate policies and motions are debated and decided. The invention may be used for the collaborative development of medical protocols, such as for disease treatment or for emergency response. The invention may also be used in negotiating contracts.

### SUMMARY OF THE INVENTION

The present invention comprises a system for enabling a plurality of geographically disparate participants to review, and vote upon, a motion. The system includes a central server, comprising a programmed computer, and a plurality of client computers, each being associated with a different participant, and each client computer communicating with the central server. The server is programmed to transmit a proposed motion to the computer of each participant, and to establish an online discussion forum, wherein the participants may ask questions and/or make comments, and wherein other participants may view the comments or questions, and may respond thereto. The central server also enables the participants to modify a motion, and enables the participants to vote on the motion.

In one embodiment, the central server is programmed to enable participants to break up a motion into clauses, and to vote on the manner in which the motion shall be broken up.

In another embodiment, the central server is programmed to compare a set of proposed clauses with the original motion, and to indicate, to participants, whether the proposed clauses together encompass all elements of the original motion. Also, it is possible for participants to propose new clauses, which were not contained in the original motion, for consideration by the group.

In another embodiment, the central server is programmed to allow participants to propose to link two or more clauses together, and to treat linked clauses in accordance with certain rules to which the participants shall have agreed.

The central server also preferably comprises means for establishing rules of participation, which rules may include a) who may participate in an online discussion and the manner of such participation, b) who is permitted to vote, and c) the weighting of the vote of each particular participant.

The invention also includes a method for enabling geographically disparate participants to review and decide upon a motion. The method includes displaying the proposed motion to the participants, on their respective computers, accepting comments and/or questions from participants, and displaying such comments and/or questions to other participants, receiving suggestions for modification of the motion, and conducting an online vote among participants, and displaying the results of the vote to all participants.

The method may further include accepting proposals from participants for breaking up a motion into clauses, and conducting an online vote on the manner in which a motion shall be broken up.

The method may also include comparing a proposed set of clauses with the original motion from which the clauses are derived, and indicating, to participants, whether the clauses include all elements of the original motion.

The method may also include accepting, from participants, proposals to link various clauses, so that linked clauses can be treated in accordance with certain rules to which the participants shall have agreed.

The method may also include establishing rules of participation for consideration of the motion, wherein said rules may include a) who may participate in an online discussion and the manner of such participation, b) who is permitted to vote, and c) the weight accorded to each participant's vote.

The present invention therefore has the primary object of providing a system which enables a plurality of geographically disparate participants to consider, and vote upon, a motion or other document intended for governance of an entity.

The invention has the further object of simplifying the governance of an entity by persons who are not located in the same place.

The invention has the further object of enabling geographically disparate participants to review and consider complex motions having a plurality of clauses, and to vote on the arrangement of such motions into clauses, and to vote on adoption of the motions themselves.

The reader skilled in the art will recognize other objects and advantages of the invention, from a reading of the following brief description of the drawings, the detailed description of the invention, and the appended claims.

### BRIEF DESCRIPTION OF THE DRAWINGS

FIG. 1 provides a flow chart illustrating the basic components of the present invention.

FIG. 2 provides a reproduction of a hypothetical screen display, representing the creation of rules module 1 of FIG. 1.

FIG. 3 provides a reproduction of a hypothetical screen display produced by the discussion module 2 of FIG. 1.

FIG. 3A illustrates a screen display showing how participants can vote on changes to wording of a motion under consideration.

FIG. 4 illustrates a screen display produced by voting module 4 of FIG. 1.

FIG. 5 provides another screen display, illustrating the results of a vote on the clause illustrated in FIG. 4.

FIG. 6 illustrates a screen display produced by rules module 6 of FIG. 1, pertaining to the break-up of complex motions into simpler clauses.

FIG. 7 illustrates a screen display produced by motion break-up module 7 of FIG. 1.

FIG. 8 provides another screen display produced by the motion break-up module 7 of FIG. 1, showing the ability of a participant to add a clause to a clause being voted upon, or to propose to add an entirely new clause to the document.

FIG. 8A provides a screen display similar to that of FIG. 8, further illustrating a step in the process of proposing a new clause which was not part of the original motion.

FIG. 9 provides another screen display produced by motion break-up module 7 of FIG. 1, showing clauses being broken up into several clauses.

FIG. 10 provides another screen display produced by motion break-up module 7 of FIG. 1, showing an error message produced to identify discrepancies in clauses to be voted upon.

FIG. 11 provides a screen display produced by block 8 of FIG. 1, relating to a broken-up motion selection voting module.

FIG. 12 provides another screen display produced by the broken-up motion selection voting module of FIG. 1.

FIG. 13 provides another screen display illustrating the broken-up motion selection voting module of FIG. 1.

FIG. 14 provides another screen display illustrating the broken-up motion selection voting module of FIG. 1, this screen being used when participants wish to break up a complex motion on a clause-by-clause basis.

FIG. 15 provides another screen display illustrating the broken-up motion selection voting module of FIG. 1, showing the appearance of clause proposals when all sets agree.

FIG. 16 provides another screen display illustrating the broken-up motion selection voting module of FIG. 1, showing an example in which participants must vote to decide whether a clause should be presented in two parts.

FIG. 17 provides another screen display illustrating the further operation of the broken-up motion selection voting module of FIG. 1, wherein there are three proposed arrangements of clauses to be voted upon.

FIG. 18 provides another screen display illustrating the further operation of the broken-up motion selection voting module of FIG. 1, wherein the next clause in all three proposed sets of clauses is the same for all sets.

FIG. 19 provides a chart illustrating the rules module for voting on complex motions, indicated as item 9 in FIG. 1.

FIG. 20 illustrates a screen display representing clause discussion forum 10 of FIG. 1.

FIG. 21 illustrates another screen display relating to the clause discussion forum 10 of FIG. 1, relating to a discussion about a particular clause.

FIG. 22 illustrates a screen display produced by the clause linkage system 11 of FIG. 1.

FIG. 23 illustrates a screen display showing the further operation of the clause linkage system 11 of FIG. 1, wherein participants indicate which clauses should be linked.

FIG. 24 illustrates a screen display produced by the linkage voting module 12 of FIG. 1.

FIG. 25 illustrates a screen display showing the results of a vote of participants to link various clauses, according to the present invention.

FIG. 26 provides a screen display produced by voting module 13 of FIG. 1.

FIG. 27 provides a schematic diagram illustrating the system of the present invention, including a central server, programmed to implement the methods of the present invention, and a plurality of remote computers, each of which is associated with a participant.

### DETAILED DESCRIPTION OF THE INVENTION

The present invention comprises a system and method which enables a group of persons, especially a geographically dispersed group of persons, to debate, and vote upon, motions or rules for governing an entity, or to negotiate collaboratively a document such as a contract.

In this specification, the following terms are used. A “simple motion” is a motion consisting of only one basic proclamation or element. A “complex motion” is a motion having several components that can be broken up into elements or clauses. In this invention, each element can be debated separately. However, elements can be related to, or dependent upon, other elements, such that one element may be contingent upon another.

A “related clause” or element is a clause or element that can be considered related to other clauses. In the present invention, relationships or linkages among clauses may be subject to a vote.

A “straight vote” is a vote in which the result is either a “yes” or a “no”.

A “weighted vote” is a vote which can be varied in strength. For example, one could vote on a scale of 1 to 5, with 1 meaning “agree”, 3 meaning “neutral”, and 5 meaning “disagree”.

The term “varied participant influence” means that opinions of participants are not of equal value. For example, the vote of the Chancellor of Germany could be given more weight than the vote of the assistant ambassador of Timbuktu.

The term “motion”, as used in this specification, includes various documents, including a motion, a rule, a proclamation, a set of rules or protocols, or other document used to govern an entity.

In this specification, the invention will be described with respect to an example wherein a band of 17th century pirates negotiates and adopts a document which will govern their operations. The example is loosely based on the story presented in the novel and film “Captain Blood”. This example is given only for clarity of illustration, and is not intended as a recommendation that the invention be used for any illegal purpose.

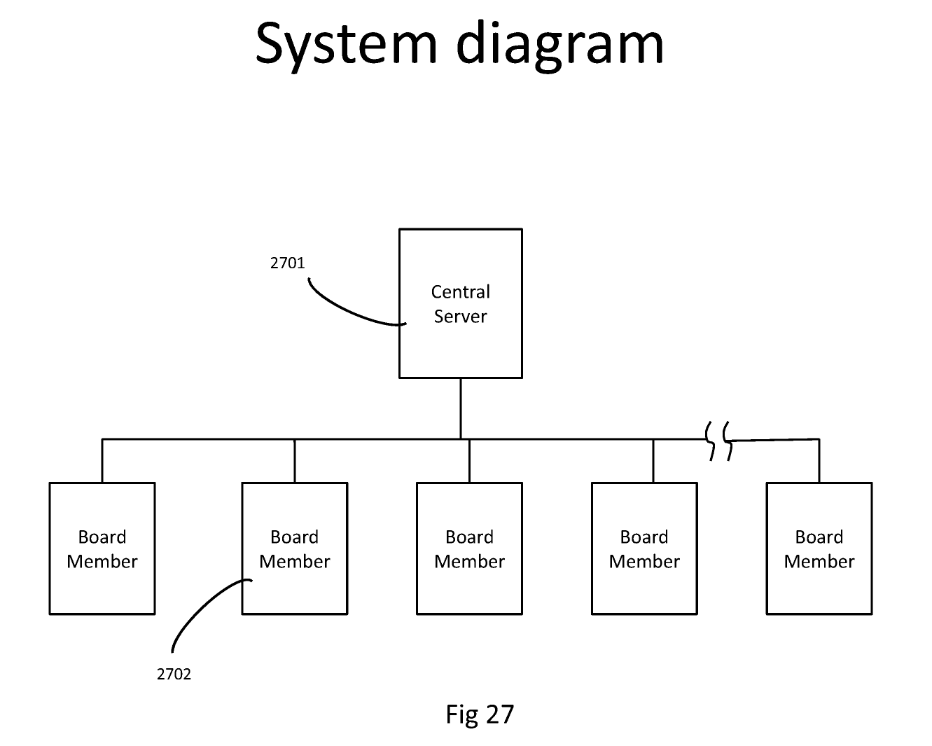

The present invention includes a system and method wherein a plurality of persons, normally but not necessarily located in geographically disparate locations, can formulate, debate, and vote on motions through an online interface which links the participants. FIG. 27 provides a schematic diagram illustrating a central server, which includes a computer which is programmed to implement the methods of the present invention, and a plurality of remote clients, each client being associated with a participant. The clients and server can be linked through the Internet, or they can be linked through other computer networking means, such as a private or internal network.

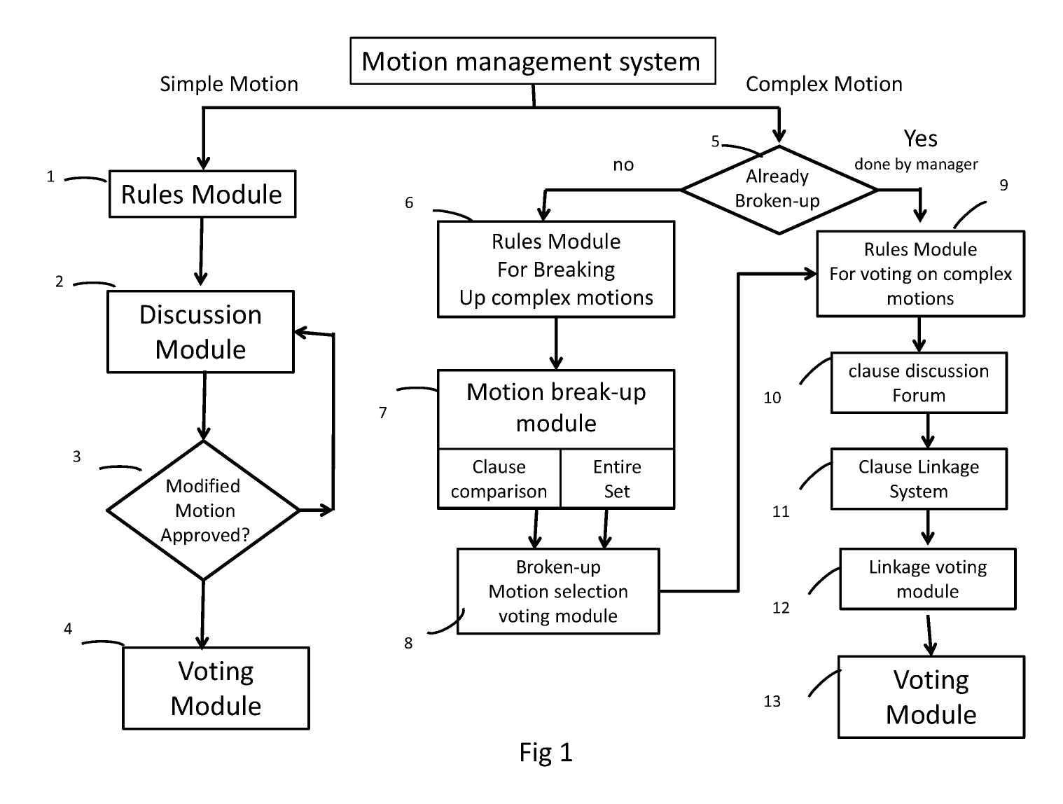

FIG. 1 provides a flow chart showing the basic operations of the present invention. The flow chart will first be described very generally, and then the details of each component will be presented more fully.

In the flow chart of FIG. 1, the system must first determine whether a given motion is simple or complex.

The following is an example of a simple motion:
We are pirates and intend to break the law in pursuit of fortune, primarily on the high seas.

The following is an example of a complex motion:
We, the undersigned, are men without a country, outlaws in our own land and homeless outcasts in any other. Desperate men, we go to seek a desperate fortune. Therefore, to that end, we enter into the following Articles of Agreement:
First: We pledge ourselves to be bound together as brothers in a life and death friendship, sharing alike in fortune and in trouble.
Second: All monies and valuables which may come into our possession shall be lumped together into a common fund . . . and from this fund shall first be taken the money to fit, rig, and provision the ship.
Third: After that, the recompense each shall receive who is wounded is follows: for the loss of a right arm: 600 pieces of eight; left arm: 500; for the loss of a right leg: 500; left leg: 400.
Fourth: If a man conceal any treasure captured or fail to place it in the general fund, he shall be marooned, set ashore on a deserted isle, and there left with a bottle of water, a loaf of bread and a pistol with one load. If a man shall be drunk on duty he shall receive the same fate. And if a man shall molest a woman captive against her will . . . he, too, shall receive the same punishment.
These Articles entered into this 20th day of June, in the year 1687.

In general, a complex motion contains multiple elements, and could be treated as one motion, or it could be treated as a combination of simple motions or statements.

If the motion is a simple motion, the system proceeds to block 1, which comprises the rules module. For simple motions, the rules module determines basic parameters such as who can vote, the weight given to each person's vote, whether a person can veto a motion, whether the vote will be a straight vote or a weighted vote, and who can participate in the forums (discussed below).

The discussion module 2 enables the participants to discuss the motion, in an online interface.

As a result of the discussions of the participants, the motion may be modified. In fact, as described in more detail below, the system may use an iterative process whereby the participants vote on changes to wording, before voting on the motion itself. Thus, the system determines, in test 3 of FIG. 1, whether the participants have agreed on a modified version of the motion. When such agreement has been reached, the participants vote on the motion itself, in voting module 4.

If the motion is complex, the system determines, in test 5, whether the motion has already been broken up into components. If not, the system enters rules module 6 which determines the parameters for breaking up complex motions. Rules module 6 will be discussed in more detail later, but, in brief, this module determines which participant may submit proposed component clauses, and which participant may vote on the break-up of clauses, and with what weight. Through motion break-up module 7, the participants then proceed to break up the motion into smaller components, according to the rules established in module 6. In voting module 8, the participants vote on how to break up the complex motion.

After the participants have determined how a complex motion will be broken up, the system continues in rules module 9, which establishes the rules for voting on complex motions. This rules module is similar in concept to rules module 1.

In block 10, the participants may engage in an online discussion forum, wherein the participants discuss proposed changes to the various clauses of the motion. In block 11, the system allows the participants to propose to link certain clauses together. In block 12, the system allows the participants to vote on the proposed linkages of clauses. Finally, in block 13, the participants can vote on the final version of the motion.

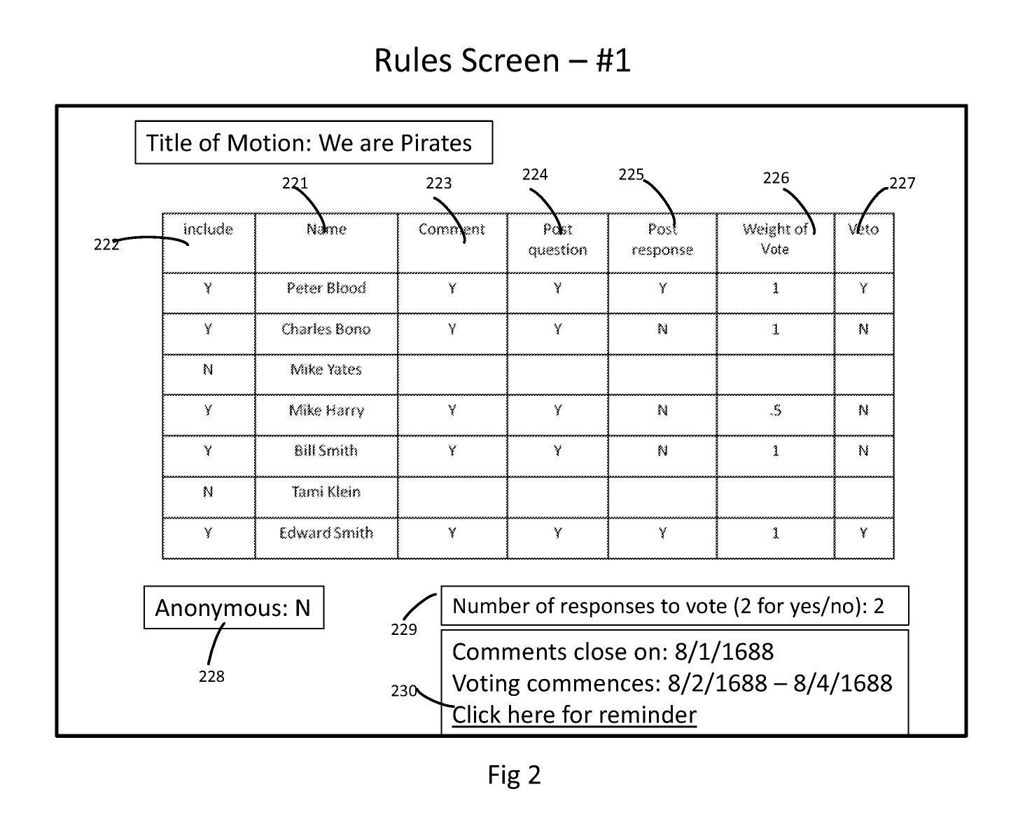

FIG. 2 shows a hypothetical screen display showing the creation of rules module 1 of FIG. 1. This screen is an interactive device; that is, an administrator or facilitator or system operator makes entries in the various blocks, described below. The collection of data indicated on the screen comprises the rules module which governs the process of deliberating and voting on the motion. The system operator or facilitator may be designated or elected by the participants. The participants could specify the choices to be entered by the system operator, or the system operator could be entrusted with the authority to make such decisions.

In general, the screen display of FIG. 2 identifies the participants and the role assigned to each participant. The rules module being created pertains only to the motion identified in the title block at the top of the screen. A separate rules module could be created for each different motion.

Column 221 shows the names of the various participants. Column 222, labeled “include”, indicates which individuals may participate in the current motion. In the example given, those who may participate are designated by “Y” (yes) and those who may not participate are designated by “N” (no).

Column 223 indicates whether or not a participant may comment on the motion (as opposed to simply voting on the motion). Column 224 indicates whether or not a participant has the right to post a question concerning the motion. Column 225 indicates whether a participant has the right to answer postings by others, relating to the motion.

Column 226 indicates the weight to be accorded to the vote of each participant. A value of “1” indicates that a participant's vote counts as one vote. But the votes of each participant can be weighted in different ways. A person's vote could be counted as a half-vote, or as two votes, or as some other number of votes.

Column 227 indicates whether a participant has veto power over a motion. Those who have veto power can defeat a motion, regardless of the number of votes cast in its favor.

Block 228 indicates whether or not the voting on the motion will be secret. In the example given, the entry in this block is “N”, indicating that the voting will be open, i.e. not anonymous.

Block 229 indicates the votes available to each participant. For example, one could simply vote “yes” or “no”, or one could enable participants to vote on, say, a scale of one to five. In block 229, the entry “2” essentially means that, in this example, the allowable votes are “yes” or “no”.

In block 230, the system operator may designate a closing date for comments, and a time period during which voting will occur. Also, by clicking on the last line in the block, the operator causes the system automatically to send an email, or other reminder, to the participants, when one or more of the above-mentioned deadlines are approaching.

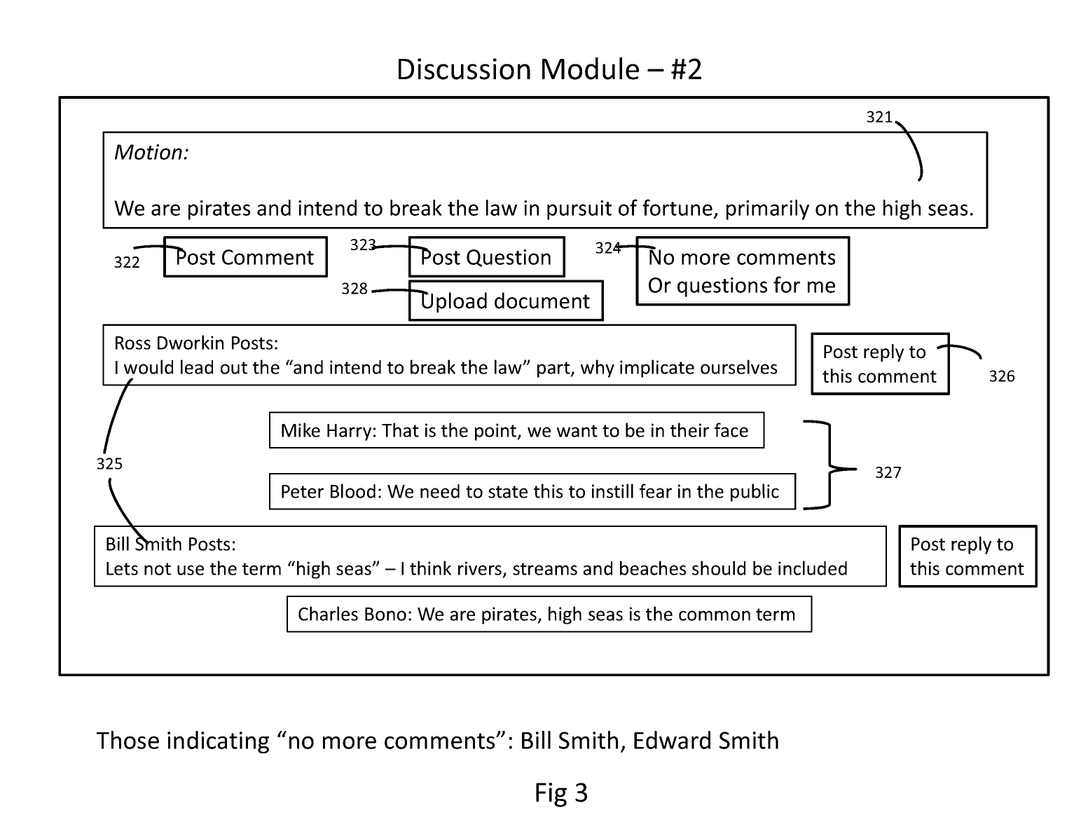

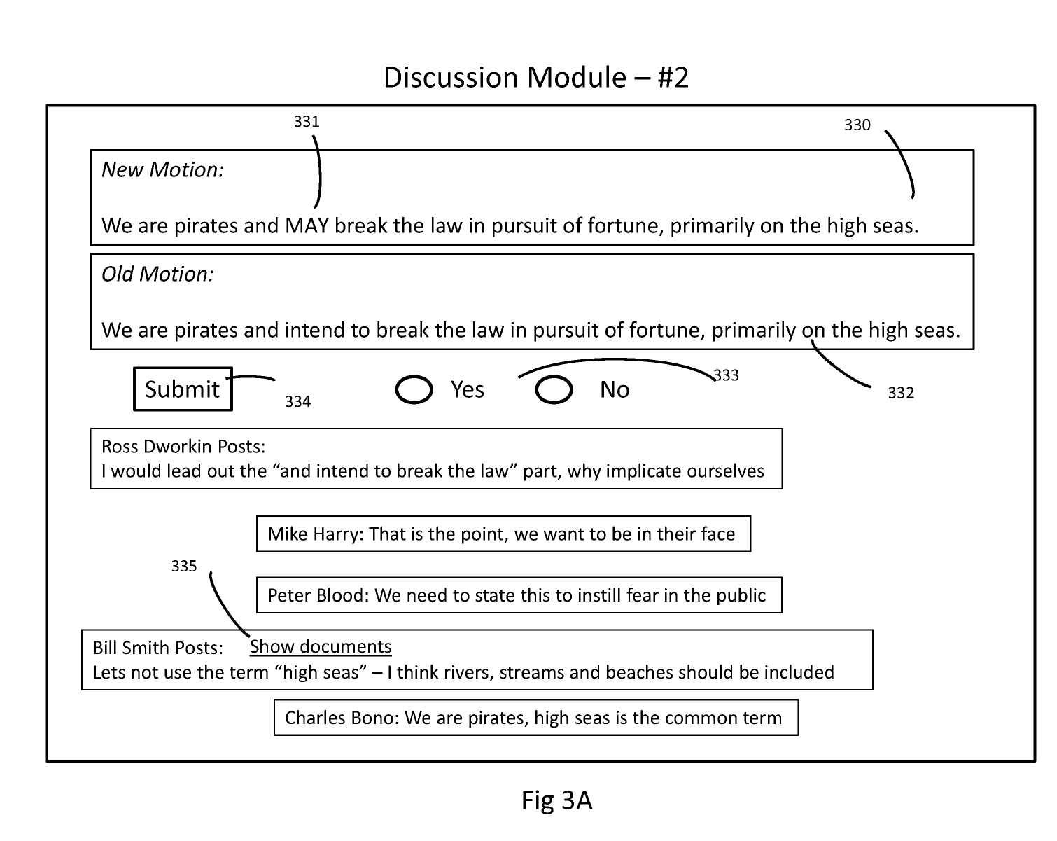

FIG. 3 illustrates a screen display produced by discussion module 2 of FIG. 1. The system essentially provides a digital forum, or discussion area, wherein participants can express their thoughts, and obtain answers to questions, relating to the motion.

Block 321 shows the text of the motion under discussion. Clicking on block 322 or block 323 enables a participant to post a comment, or to post a question, respectively, provided that the person clicking the block has previously been authorized to post a comment or question. Block 328 enables a participant to upload a document, which may be relevant to the discussion, again provided that the participant is authorized to upload documents.

When a participant has made up his or her mind, that participant may click on block 324, to signify that fact. The purpose of this function is to advance the discussion process, and to bring the motion closer to a vote.

Blocks 325 illustrate sample comments relating to the motion. Block 326 enables an authorized participant to post a reply to the comment shown to the left of the block. Block 326 is automatically disabled, or greyed-out, if the participant is not authorized to reply, as determined by the rules module 1. Blocks 327 illustrate sample comments relating to other comments.

If there are substantial objections to the wording of the motion, the participants may vote on proposed changes to the wording. Such vote is not considered a vote on the motion itself. FIG. 3A illustrates the process wherein the participants vote on proposed changes.

In FIG. 3A, the motion proposed in FIG. 3 is shown in block 332. Based on the comments and suggestions made by the participants, as shown in FIG. 3, the facilitator or administrator posts a new proposed motion, shown in block 330. In the example given, the new motion differs in the use of the word “may” instead of “intend to”, as indicated by reference numeral 331.

FIG. 3A also includes a voting mechanism 333, wherein voting participants may vote on the proposed change. A vote is cast by clicking on the “yes” or “no” button, and then clicking block 334, which submits the vote.

Reference numeral 335 refers to the use of documents in conducting the discussion. In FIG. 3, a participant may upload a document, in support of a comment, by clicking block 328. By clicking the link “show documents”, indicated by reference numeral 335 of FIG. 3A, a participant may view the document(s) previously uploaded by “Bill Smith”.

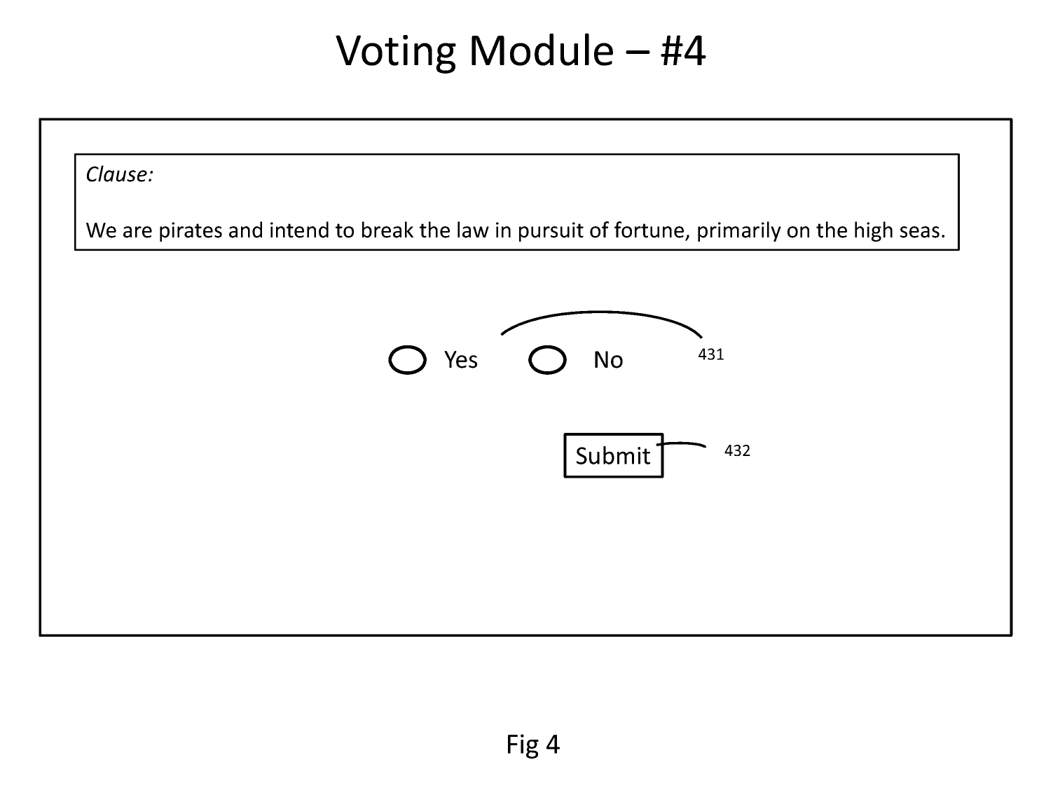

Eventually, the above-described process converges on a selected text of the motion, and the participants can vote, in voting module 4 of FIG. 1. The voting module is also shown in the screen display of FIG. 4. A participant selects “yes” or “no”, as indicated by reference numeral 431, and clicks the “submit” button 432 to cast the vote. The system is programmed to ignore any attempted vote by a person not permitted to vote, as determined by rules module 1.

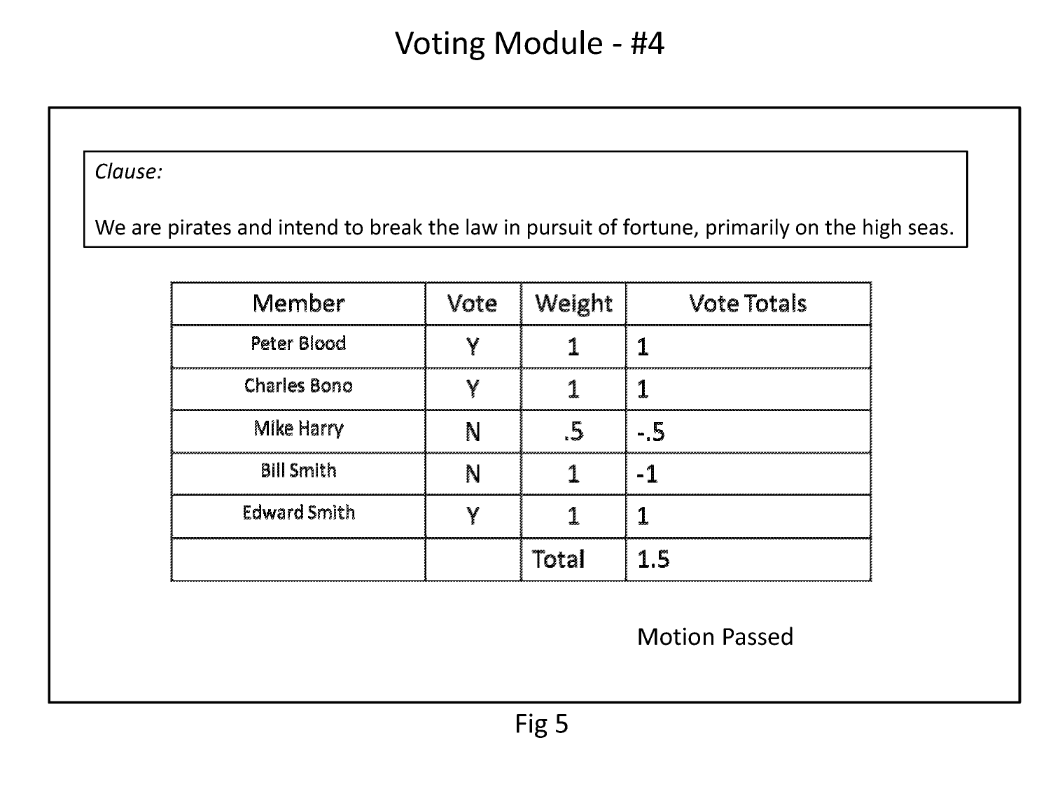

FIG. 5 illustrates a screen display generated by the system, showing the results of the vote. The display shows the vote of each participant, the weight accorded to each vote (as determined by the rules module), and the weighted totals. In general, a “yes” vote is recorded as a positive number, and a “no” vote is recorded as negative. Therefore, if the weighted result is positive, the motion passes. If the weighted result is negative, the motion fails. Note that the same rule applies whether or not the votes are equally weighted. The system can be programmed, in advance, to handle the case of a tie. In a preferred embodiment, the system will treat a tie vote as a failure to pass the motion.

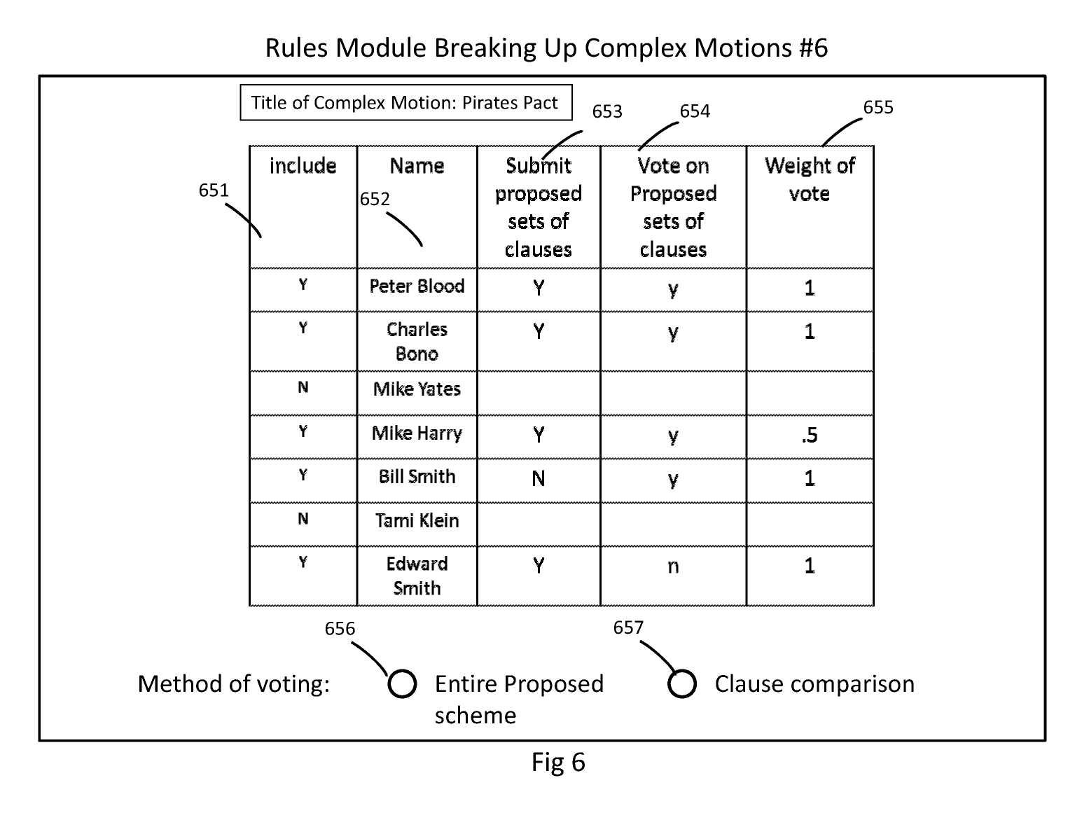

FIG. 6 illustrates a screen display pertaining to block 6 of FIG. 1. This display is analogous to FIG. 2, as it provides a rules module, except that this module relates to complex motions, and except that this module relates to the break-up of a complex motion, not to voting on the motion itself. As before, the display is presented to the system operator or facilitator in blank form, and the operator makes entries in the various spaces, thereby determining the rules governing the deliberation on the complex motion.

Column 651 determines which participants will be allowed to participate in the process of breaking up the complex motion. The possible participants are identified in column 652. Note that in rows in which the operator has entered an “N”, indicating that a particular person is not authorized to participate, no other information is entered, as it would be unnecessary.

Column 653 determines which participants are permitted to recommend how complex proposals should be broken up into a set of clauses or simple motions. Column 654 determines which participants may vote on how to break up a complex narrative into clauses. Column 655 determines the weight of the vote accorded to each voting participant.

In the present invention, the participants may vote on breaking up a complex motion in one of two ways. The first way, indicated by selecting item 656, is to vote for proposed sets of clauses in their entirety. In this alternative, participants vote for one recommended set of clauses or another, and the proposal with the most votes (or, more precisely, the highest score), becomes the expression used in the complex motion.

The alternative way, indicated by selecting item 657 in FIG. 6, is to allow participants to compare clauses across all proposals submitted, and to allow participants to vote on which clauses they prefer. In some cases, a clause of one proposal may be equivalent to several clauses of another proposal. The system effectively builds a set of clauses based on parts from all the proposals submitted. The system does so in such a way that it will not omit any of the original content, but will also not duplicate clauses. Both of the above methods will be described below.

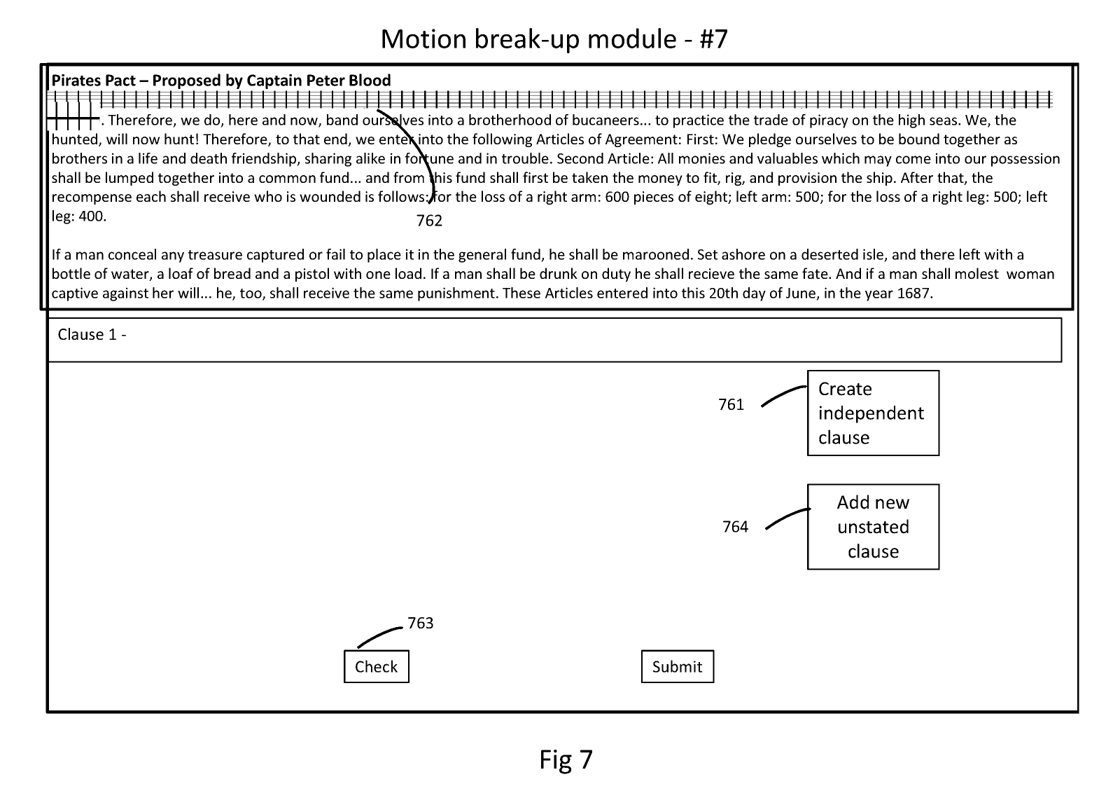

FIGS. 7-13 describe the embodiment wherein the participants vote on sets of clauses in their entirety. FIG. 7 depicts a sample screen which can be used by those participants authorized (as specified in the rules module) to submit proposed sets of clauses.

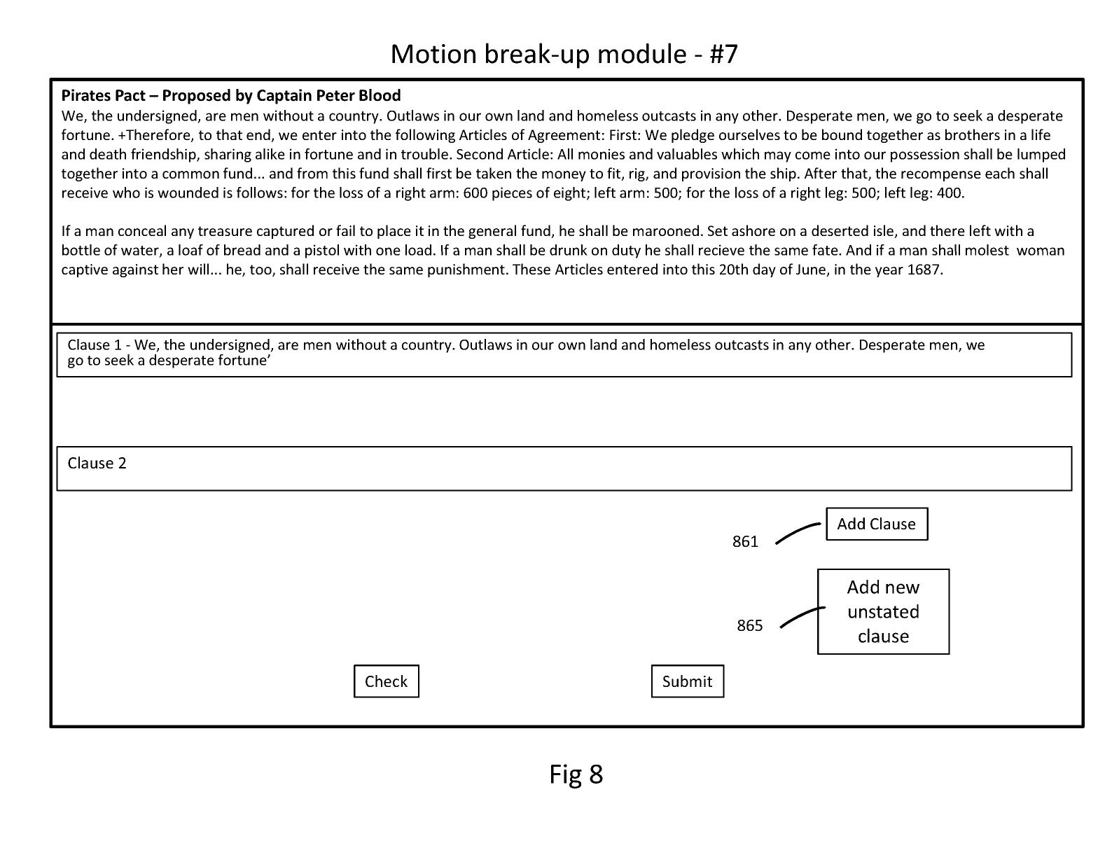

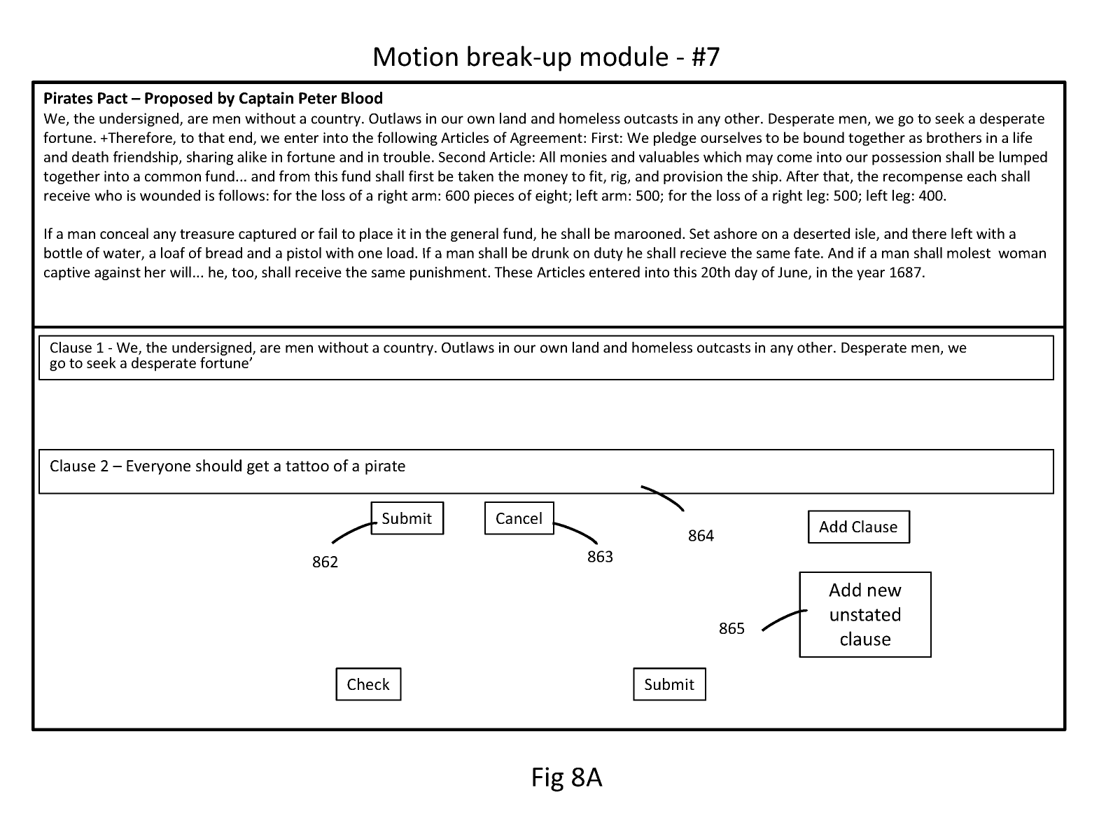

The complex motion is shown in the upper portion of the screen. Assume that the participant wishes to break this motion into a plurality of simple clauses. The participant clicks block 761, which creates an empty box labeled “Clause 1”. The participant then highlights a desired portion of the text, the highlighted portion being indicated by reference numeral 762, and pastes that text into the box labeled “Clause 1”. FIG. 8 shows the result, wherein the highlighted portion is entered in the box labeled “Clause 1”. Block 763 is used at the end of the process, to enable the participant to check that the clauses created encompass all of the words of the complex motion.

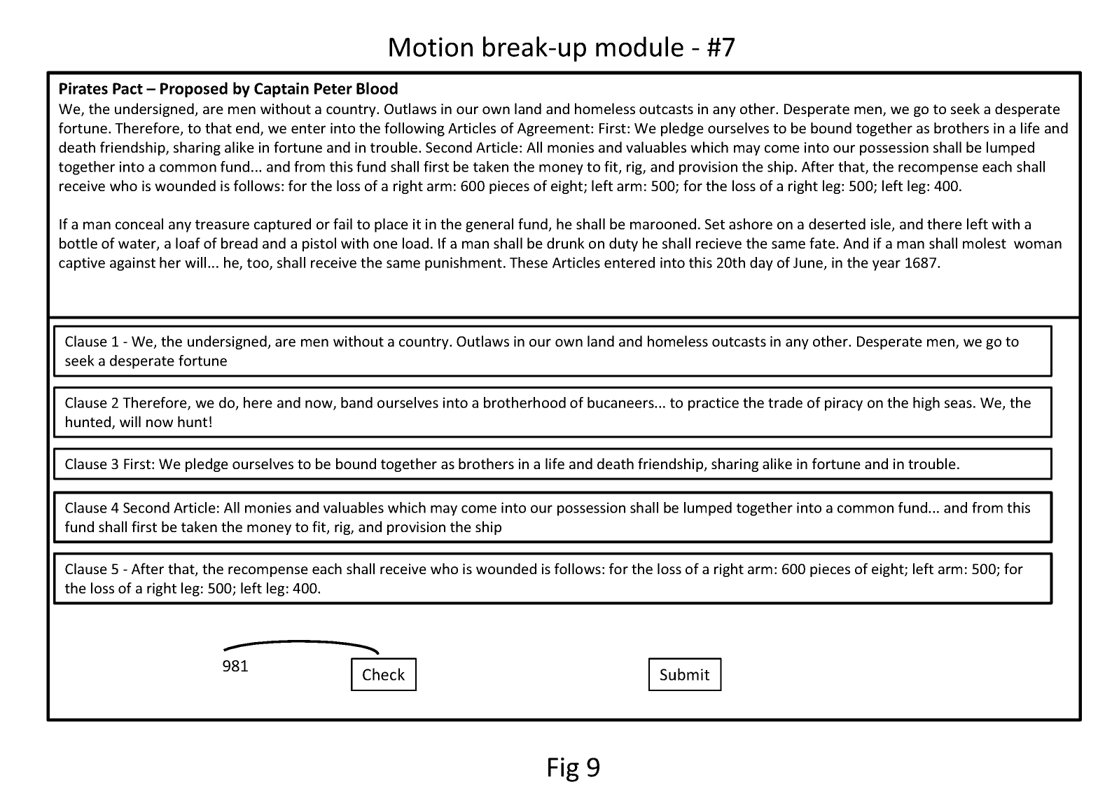

The participant may continue in this manner, by clicking block 861 (corresponding to block 761 of FIG. 7), and creating more independent clauses from the basic text. The result of several such steps is shown in FIG. 9. In the example given, there are five independent clauses. Clicking on block 981 causes the system to check whether the independent clauses together encompass the entire original text shown in the upper portion of the display.

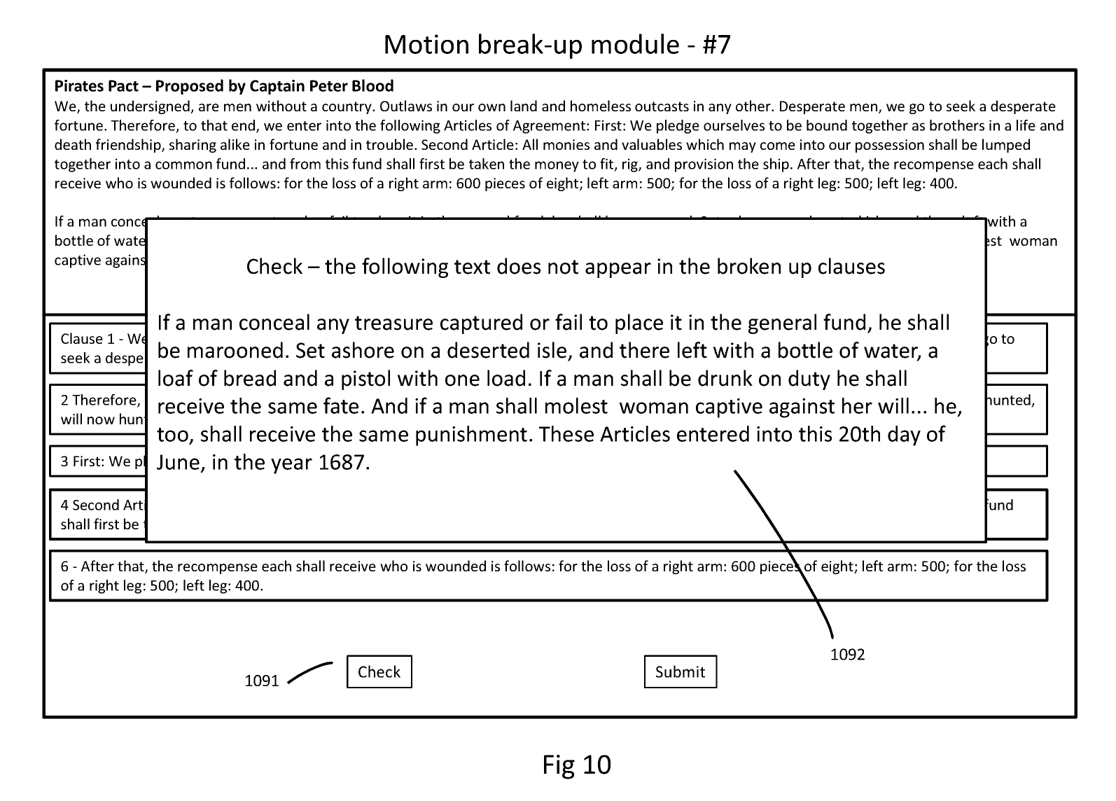

FIG. 10 illustrates an error message generated by the “check” function described above. That is, when the participant clicks the “check” block 1091, the system will examine all the words and/or sentences in all of the clauses, and will compare them to the words and/or sentences in the original text. If there are discrepancies, they are reported in box 1092. This feature is intended as an aid or utility, to help the participant in creating the smaller set of clauses. Its findings do not need to be followed or obeyed by the participant. However, it is preferable that the system retain a record of the fact that the utility was run, and its results ignored.

Another important feature of the invention is represented by block 764 of FIG. 7. Through this feature, the participant has the opportunity not only to suggest a manner of break-up of a proposed motion, but also to add one or more new clauses which were not part of the original motion under consideration. This feature is invoked by clicking on block 764. The participants therefore have the flexibility to mold the final document by adding whatever proposed clauses they wish. A similar block 865 is shown in FIG. 8.

FIG. 8A shows a screen display illustrating the addition of new clauses. By clicking on block 865, the participant is given the opportunity to add the new clause. Clicking on block 862 causes the new clause to be submitted to the system. Clicking on block 863 cancels the proposed new clause. A hypothetical new clause is shown as Clause 2 in block 864.

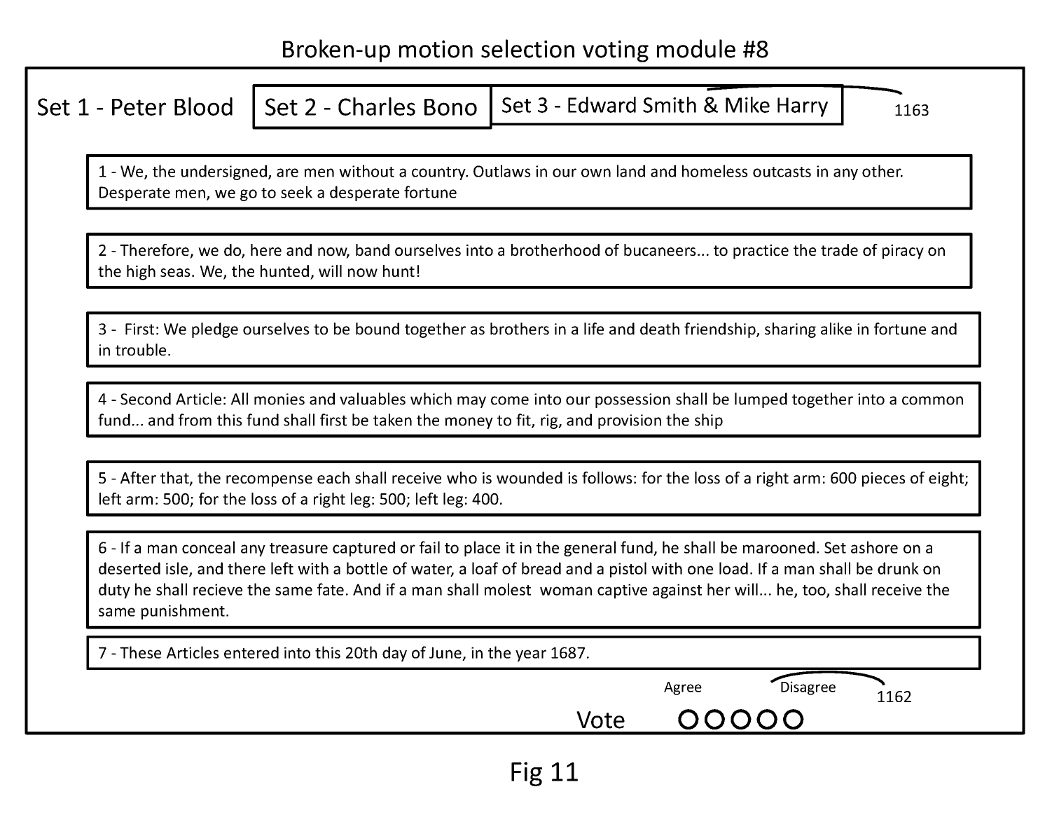

FIGS. 11-13 depict screen displays illustrating the process of voting on the ways to break up a complex motion, as represented by block 8 of FIG. 1. Note that these figures do not represent the vote on the motion itself, but rather represent a vote on how the motion should be broken up.

In FIG. 11, blocks 1163 indicate the various proposed arrangements of clauses. In the example shown, there are three sets of broken-up motions, one by Peter Blood, one by Charles Bono, one by Edward Smith, and one by Mike Harry. The latter two are combined by the system because they are identical. These arrangements of clauses are displayed by tabs at the top of the display, and are labeled “Set 1”, “Set 2”, and “Set 3”. In the example shown, the proposed division into clauses is that of Peter Blood, i.e. Set 1. The participant can vote on this arrangement, as indicated by reference numeral 1162. The system will accept a vote only from participants who have authority to vote, as determined by the rules module. Note that, as explained above, the participant must vote on the set of clauses as a whole.

Because several participants might propose the same clause structure, the system is programmed to combine such proposals. Thus, in the example given, Set 3 has been proposed both by Edward Smith and Mike Harry.

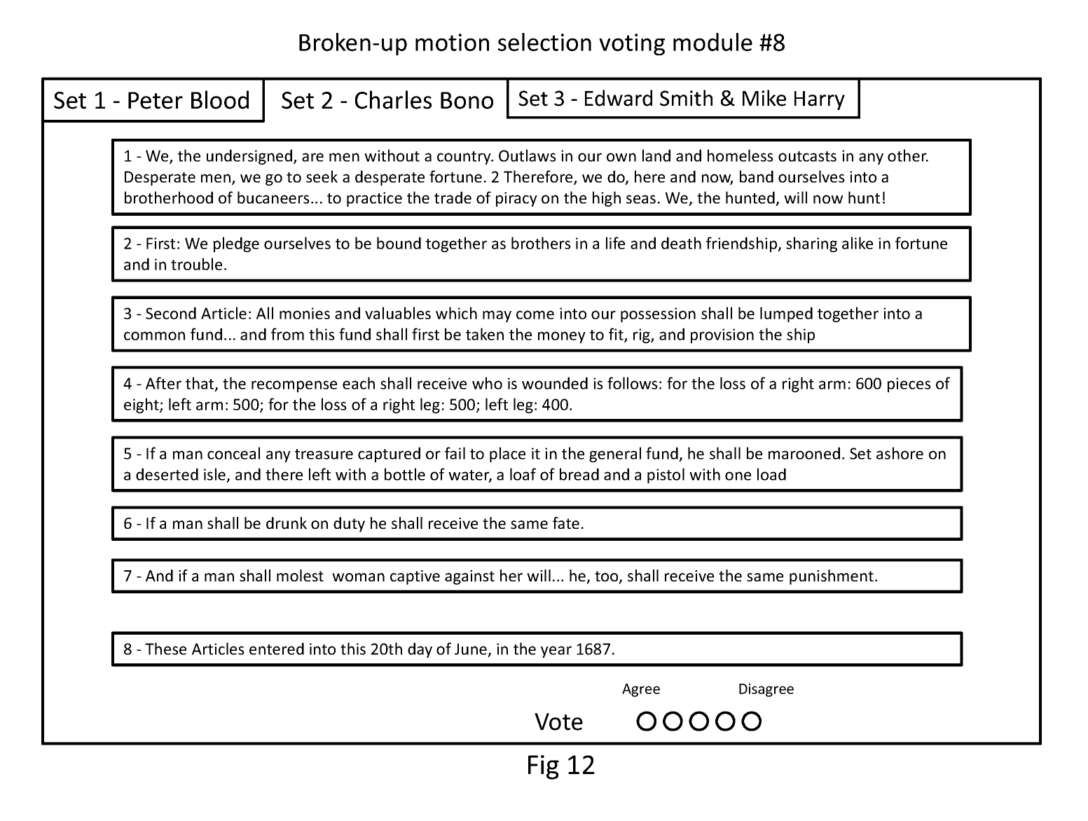

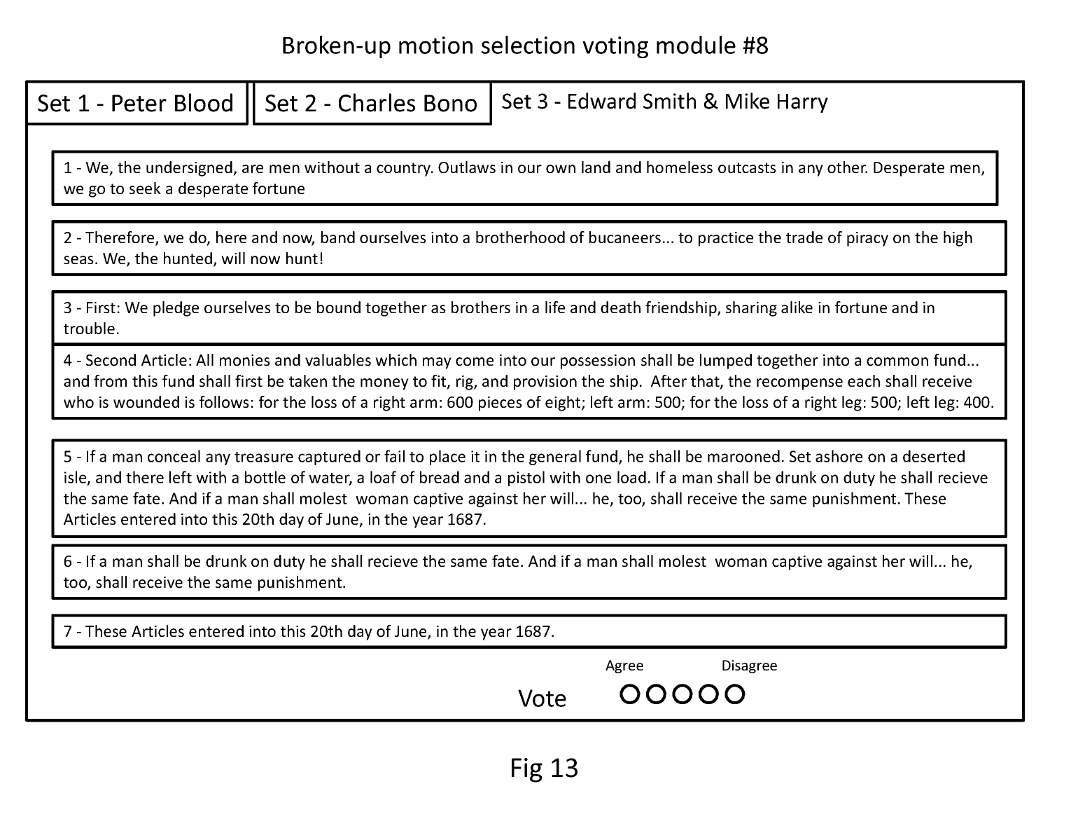

FIG. 12 is similar to FIG. 11, except that it shows Set 2, the arrangement of clauses proposed, in this example, by Charles Bono. FIG. 13 shows the same concept, but now Set 3 is displayed. In all cases, the participant can vote as indicated. The set with the most votes, or the highest weighted vote score, wins.

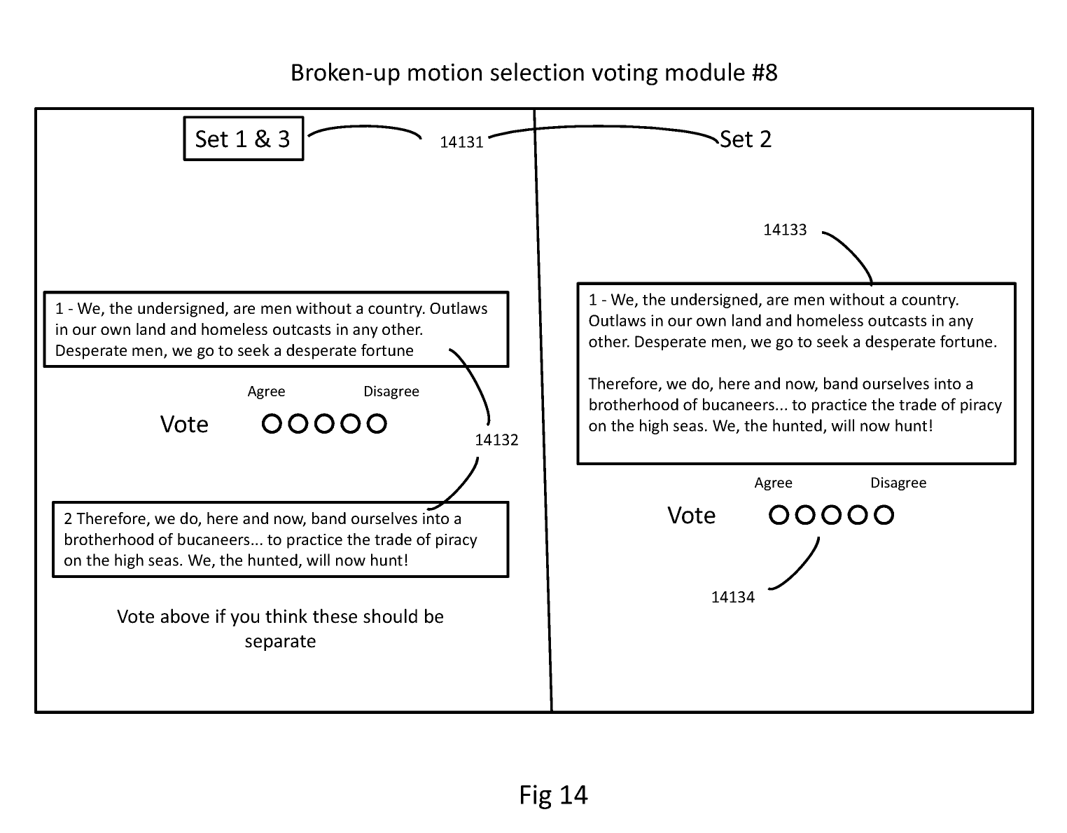

FIGS. 14-18 illustrate the alternative embodiment in which participants may compare clauses across all proposals submitted, and may vote on which clauses they prefer. These figures therefore also pertain to blocks 7 and 8 of FIG. 1.

The display in FIG. 14 illustrates a case in which there are three sets of clauses. The display indicates, as shown by reference numeral 14131, the set containing the clause (or group of clauses) illustrated below. Reference numeral 14132 indicates the first two clauses, which have been broken up from a large complex motion originally proposed. Reference numeral 14133 indicates the first clauses as proposed in Set 2, which happens to be equivalent to a combination of Clauses 1 and 2 from Sets 1 or 3.

In the example given, Clauses 1 and 2 of Sets 1 and 3 are the same, and are therefore displayed together. The system allows a participant to compare these clauses with Clause 1 from Set 2.

Voting button 14134 allows the participant to vote on the proposed arrangement of clauses. In one embodiment, the participant may vote for one arrangement or the other, but not both. That is, in FIG. 14, the participant may vote by indicating a choice on the left-hand side of the screen or the right-hand side, but not both. But, in an alternative, it is possible to allow participants to vote on both sides, presumably expressing different degrees of approval or disapproval for the respective proposed arrangements.

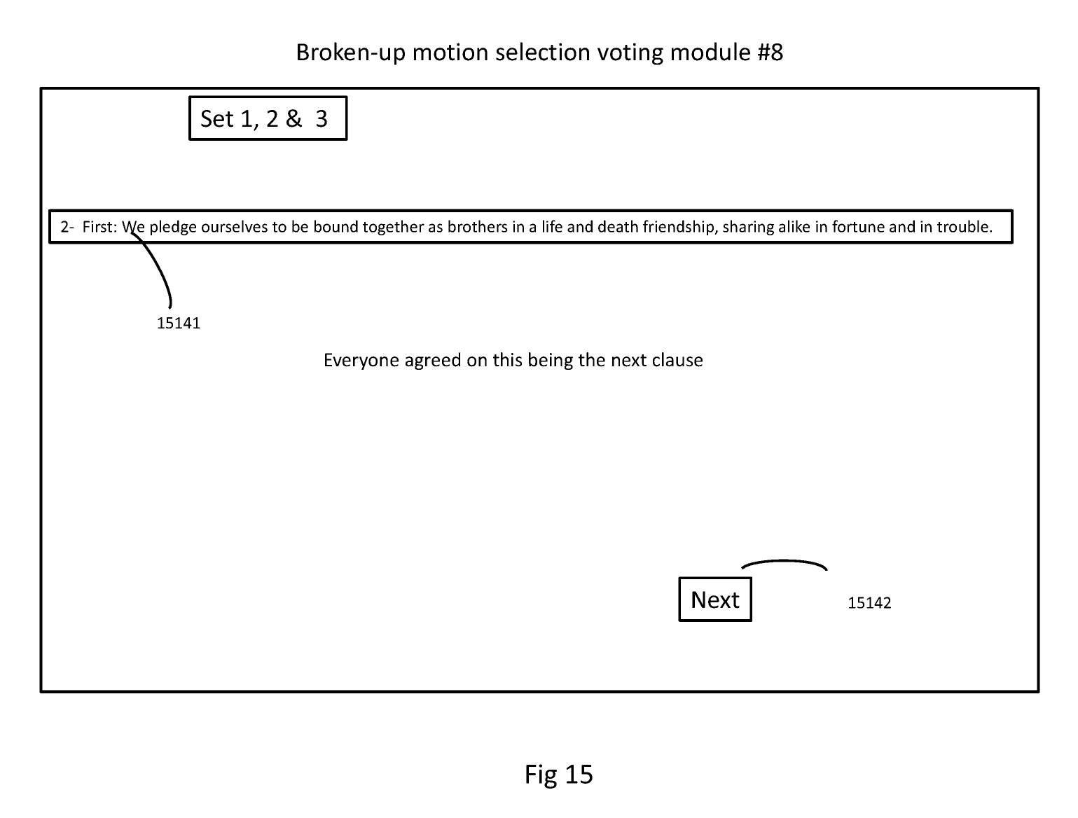

FIG. 15 illustrates a screen display in which all three sets of clauses are in agreement on the form of the next clause. Reference numeral 15141 indicates the next clause in this example, and it is automatically selected. Button 15142 allows the participant to move on to the next clause. Note also that in the example given, the larger clause on the right-hand side was selected, so the clause shown in FIG. 15 is Clause 2. If the two clauses on the left-hand side of FIG. 14 had been selected, the next clause, shown in FIG. 15, would have been numbered as Clause 3.

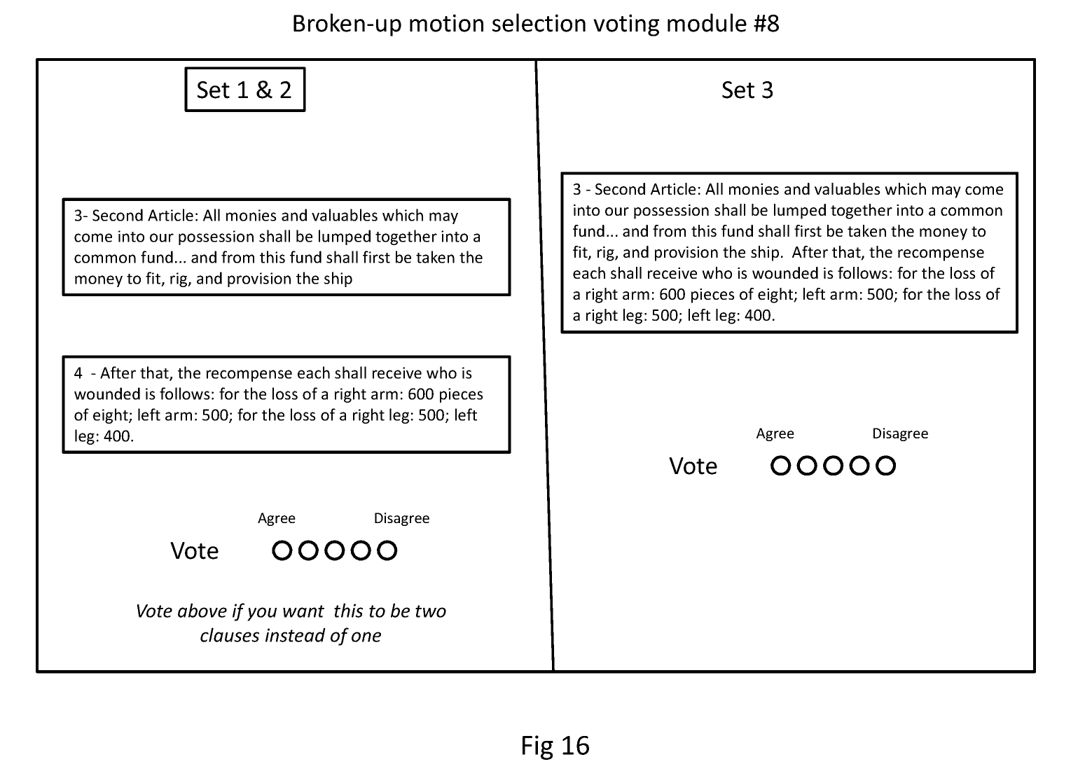

In FIG. 16, the next clause in Set 3 (shown on the right-hand side) is equivalent to the next two clauses in Sets 1 and 2 (shown on the left-hand side). The participant is therefore given the opportunity to vote on whether the clauses should be expressed as one or two clauses.

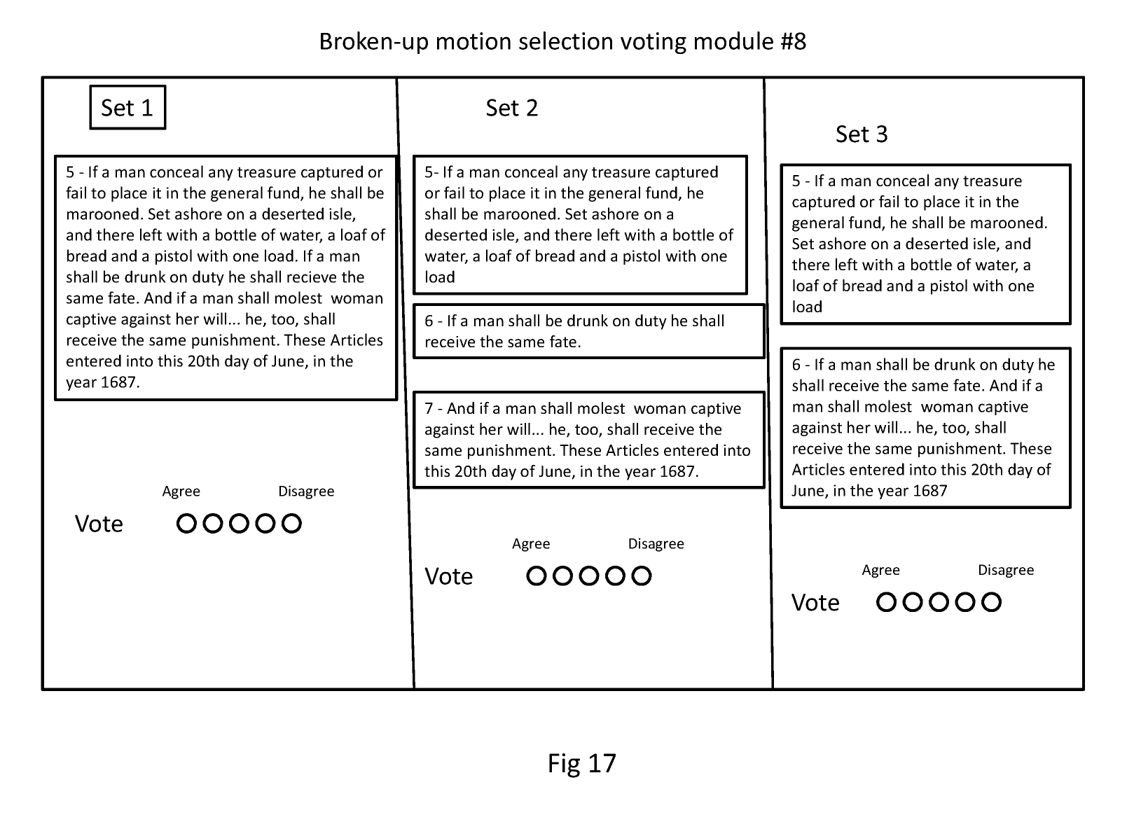

FIG. 17 provides an example wherein there are three different sets of proposed arrangements of clauses. In one preferred embodiment, the participant may vote for only one of the three sets. In the more general embodiment, the participant could enter votes relating to all three arrangements, and could express differing opinions about each.

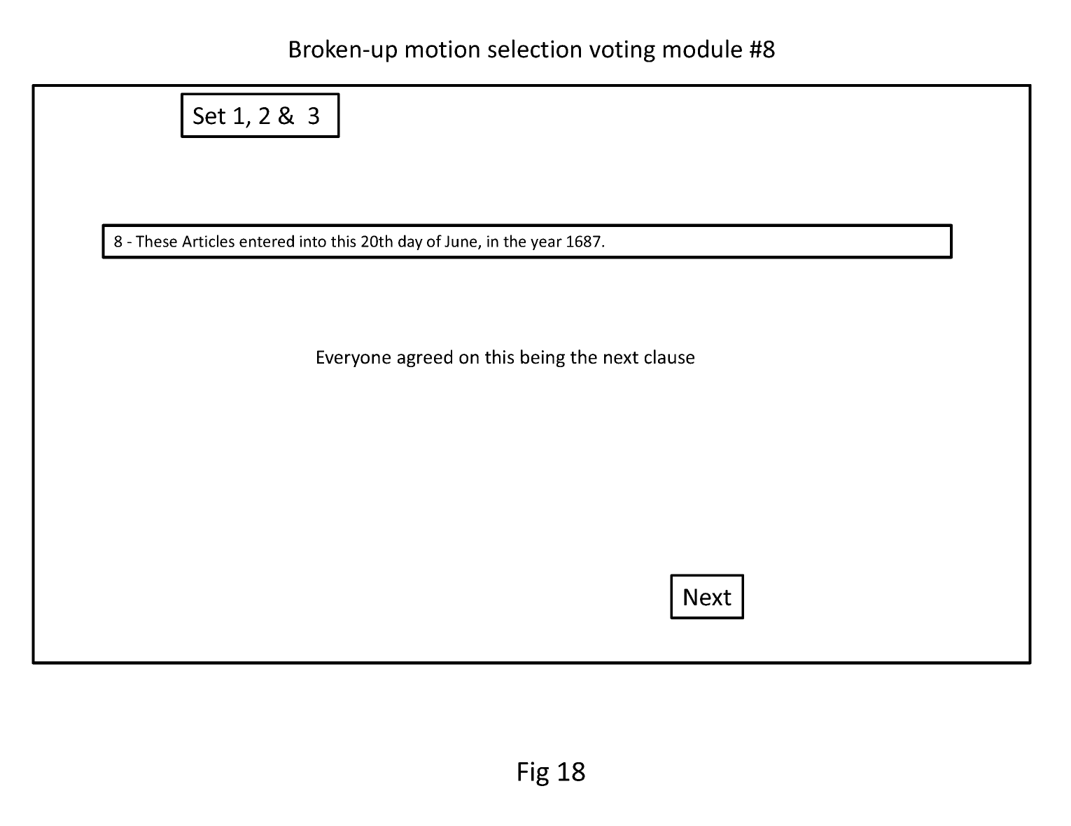

In FIG. 18, the next clause is the same for each of Sets 1-3. The system therefore presents this clause as a decided matter, not requiring a vote. The participant is simply informed that everyone has agreed that the clause shown should be the next clause, and the participant may click the “Next” button to proceed.

After a complex motion has been broken up into clauses, and the participants have agreed upon how the motion should be broken up, the participants must debate the clauses and vote on the motion.

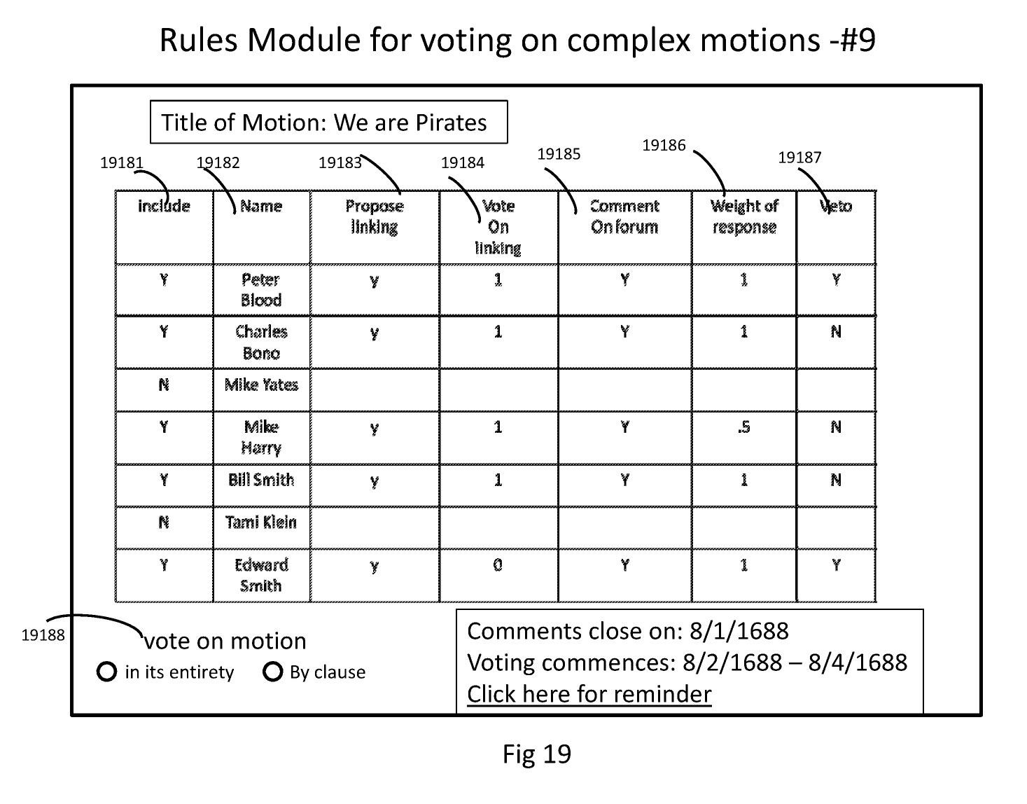

FIG. 19 shows a screen display corresponding to the rules module 9 for voting on complex motions (see FIG. 1). This rules module is analogous, but not identical, to rules module 1.

The title of the motion is shown at the top of the screen display of FIG. 19. Column 19181 indicates whether a particular participant, identified in column 19182, will be included in the vote. Column 19183 indicates whether a participant is allowed to propose that specific clauses be linked to one another. Linking of clauses is discussed in more detail later.

Column 19184 indicates whether a participant may vote on linking, and also indicates the weight of the vote. Thus, if the value is zero, the participant may not vote (the weight of the vote is zero). A value of “1” means that the participant can vote, and the vote counts as one vote. If the value is nonzero but not equal to one, the value indicates the weight of the vote.

Column 19185 indicates whether a participant may post a comment on the discussion forum which will be conducted for this motion.

Column 19186 indicates the weight of each participant's vote, when a vote is held on the overall motion. This vote is different from the vote indicated in column 19184, which relates only to the issue of linking. As before, a zero entry means that a participant may not vote (i.e. the weight of the participant's vote is zero). A value that is nonzero and not equal to one indicates the vote of the participant is weighted according to that value.

Column 19187 indicates whether a participant has a veto, i.e. whether the participant can defeat a motion or clause with a “no” vote.

Button 19188 determines whether the motion must be voted on in an “all or nothing” manner (alleviating the need for clause linking), or whether it can be voted on clause by clause.

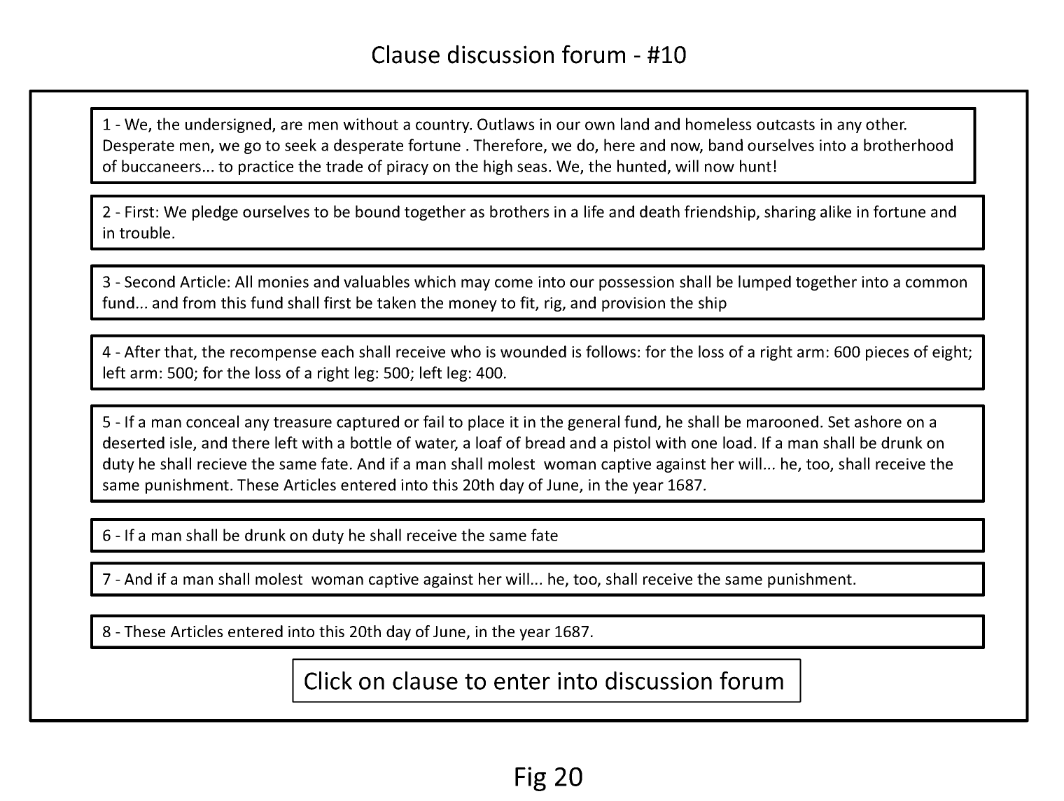

FIG. 20 illustrates a display screen representing a home page for the discussion forum for an individual clause. The clause discussion forum is also represented by block 10 of FIG. 1. In FIG. 20, a participant is presented with the various clauses of the complex motion, which clauses have previously been agreed upon, the clauses being numbered according to the agreed arrangement. To enter the forum, the participant clicks on the clause on which a comment is to be made.

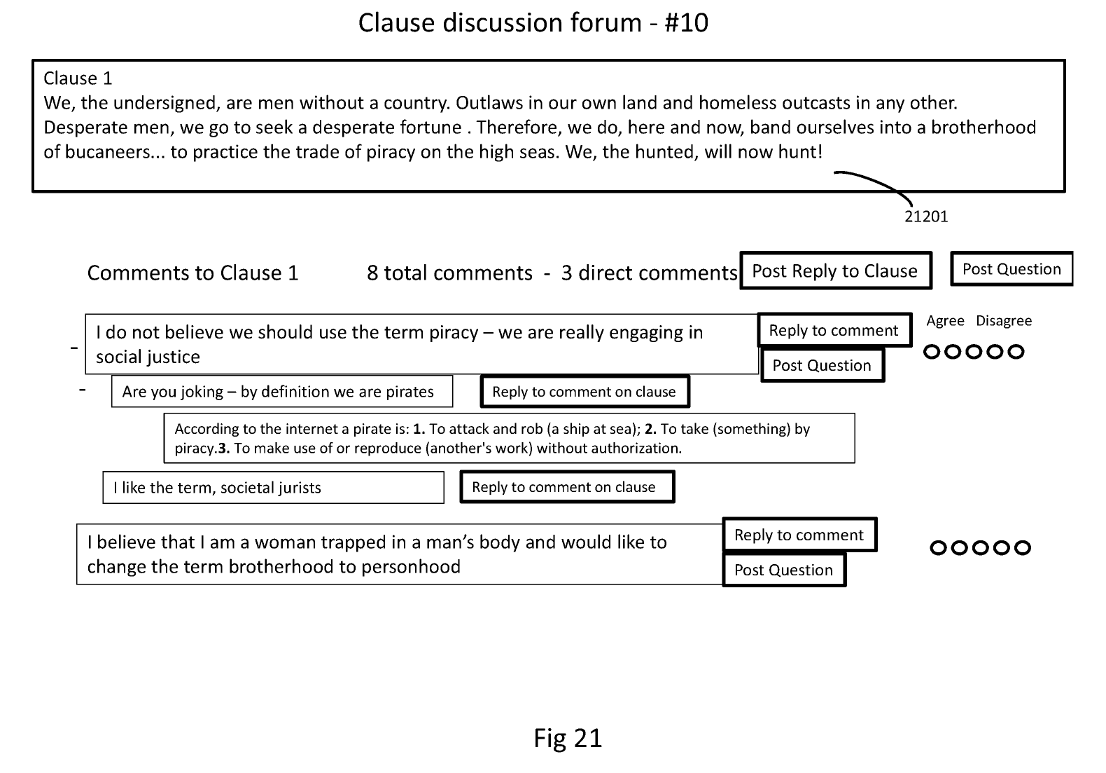

FIG. 21 illustrates the clause discussion forum with regard to Clause 1. The clause under discussion is reproduced in block 21201. The various blocks allow participants to post a comment or question on the clause itself, or to post a comment or reply to another participant's comment. The system also allows participants to voice agreement or disagreement with regard to particular comments.

An important part of the present invention is the ability to enable authorized participants to recommend that clauses be linked together, so that they must be subject to rules applying to linked clauses. For example, if two clauses are linked, the rules could require that both clauses be passed in order for either to pass, or that the approval of one of the clauses implies approval of the other. Other rules regarding linkage could be devised, within the scope of the invention.

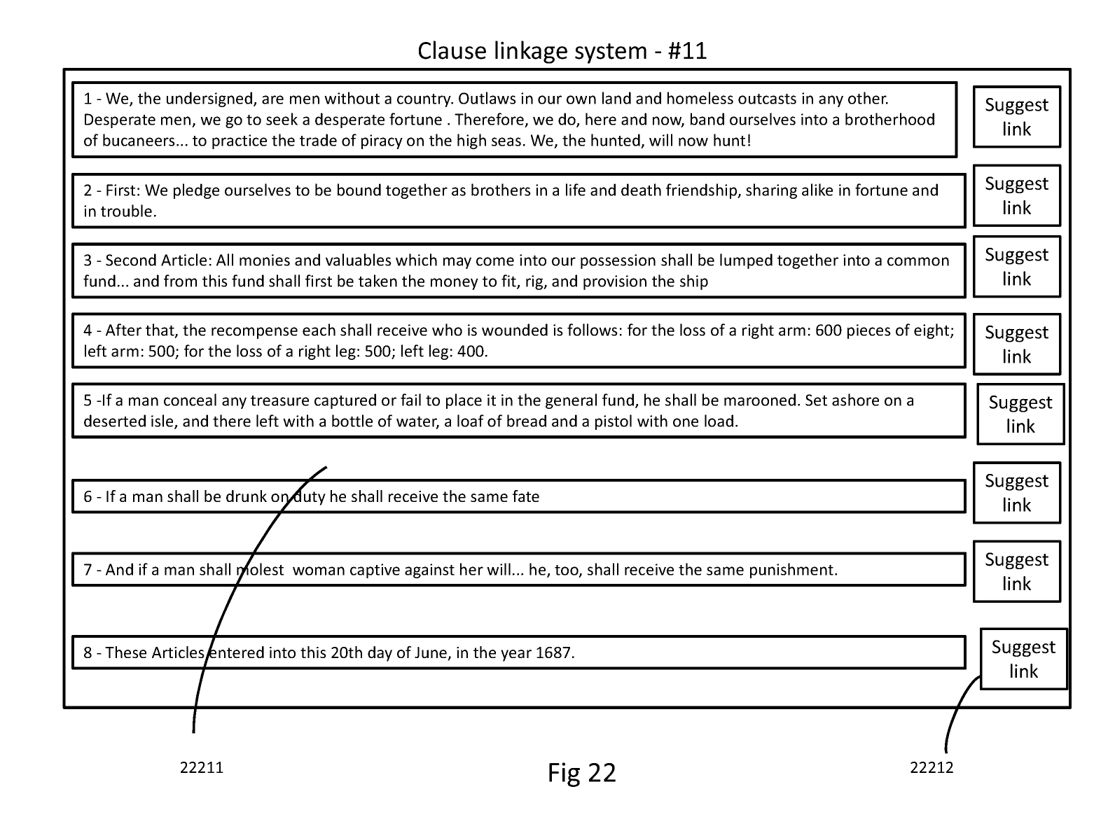

FIG. 22 illustrates a screen display generated by the above-described linkage system. This function is also indicated symbolically by block 11 of FIG. 1. In FIG. 22, the clauses of the complex motion, which have previously been broken up in an agreed manner, are shown in a list 22211, and the participants may suggest a link by clicking on one of the blocks 22212. By clicking on a “suggest link” button adjacent to a clause, the participant is indicating a recommendation that this clause be linked to another clause or other clauses.

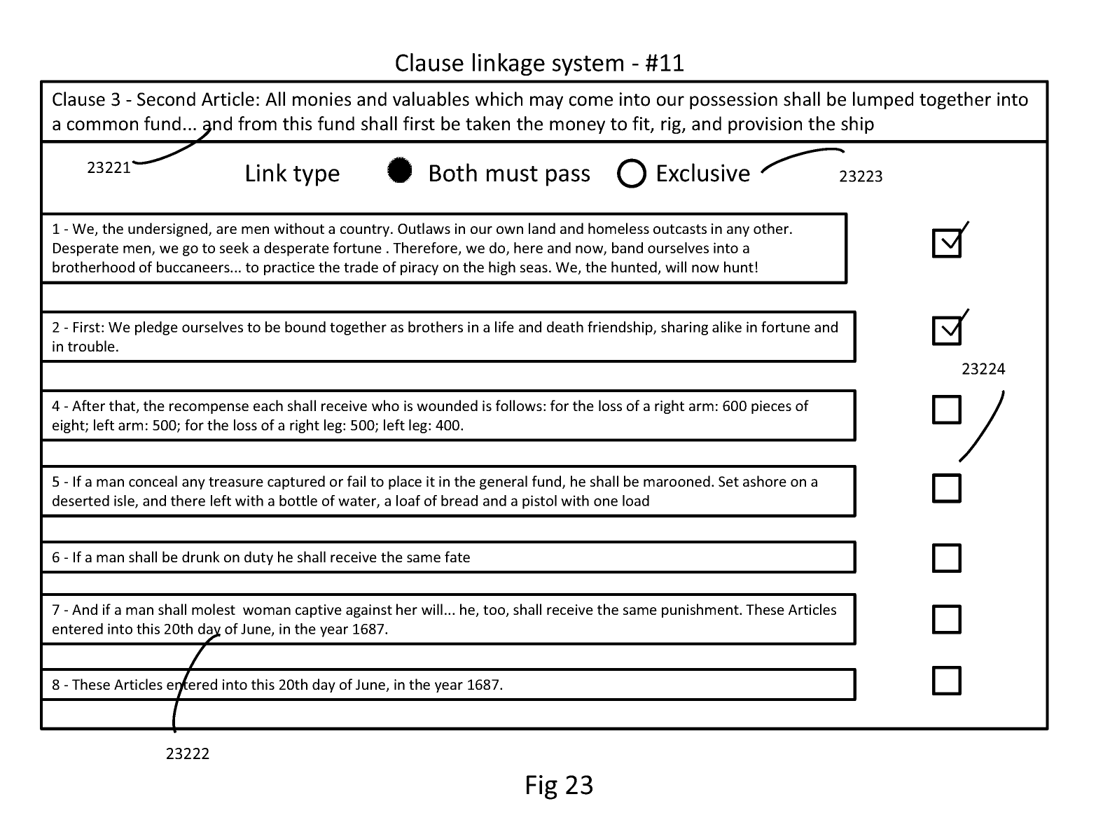

FIG. 23 provides a screen display showing further details of the clause linkage process. In the example shown, it is assumed that a participant has recommended that Clause 3 be linked to one or more other clauses. Therefore, Clause 3 is reproduced, in block 23221, at the top of the screen. The other clauses of the motion are illustrated below, as indicated by reference numeral 23222. By clicking on the appropriate check box 23224, a participant indicates that the indicated clause should be linked to the clause in block 23221.

The “link type” 23223 indicates the type of linking desired by the participant. This section determines the rule to be applied to the linking. The example given in FIG. 23 is different from the example given above, with respect to FIG. 22, and provides an additional alternative. In particular, the option “both must pass” means that the linked clauses are voted upon together, whereas the option “exclusive” means that the clauses are voted upon separately, and one or the other clause will be adopted, but not both. Any or all of the above-described examples can be used in constructing rules for linking clauses.

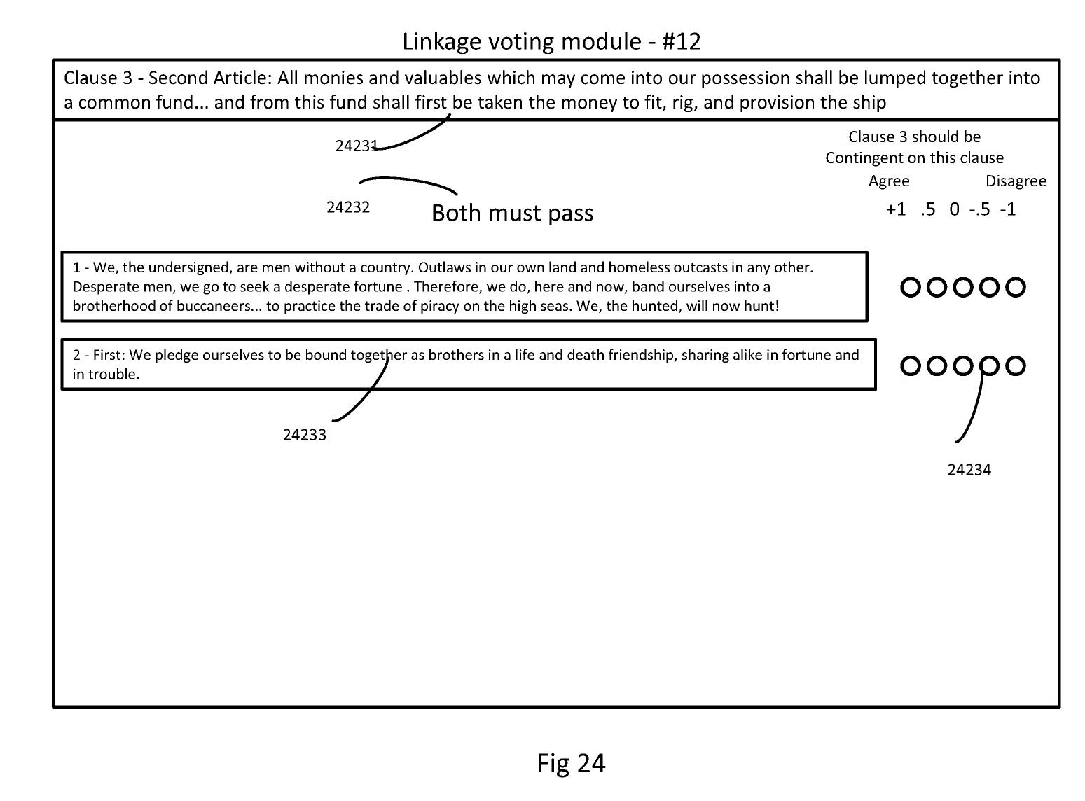

FIG. 24 depicts a screen display relating to voting on proposed linkages of clauses. This display corresponds to block 12 of FIG. 1. Block 24231 shows the primary clause driving the linkage, i.e. the clause previously selected to be linked to one or more other clauses. Reference numeral 24232 indicates the type of linking recommended; in this example, the participant has recommended that both clauses must be voted upon together.

In the example represented by FIG. 24, Clause 3 is the “reference” clause, as shown in block 24231. The reference clause is the clause to which other clauses may be linked. It is assumed that Clauses 1 and 2, shown in blocks 24233, have been previously proposed for linkage to Clause 1. The display also includes a indication 24232 showing the type of linkage proposed. Participants may vote on the proposed linkages at the right-hand side, as indicated by reference numeral 24234. In the example given, the participants may provide a weighted vote, indicating their degree of agreement or disagreement with the proposed linkage.

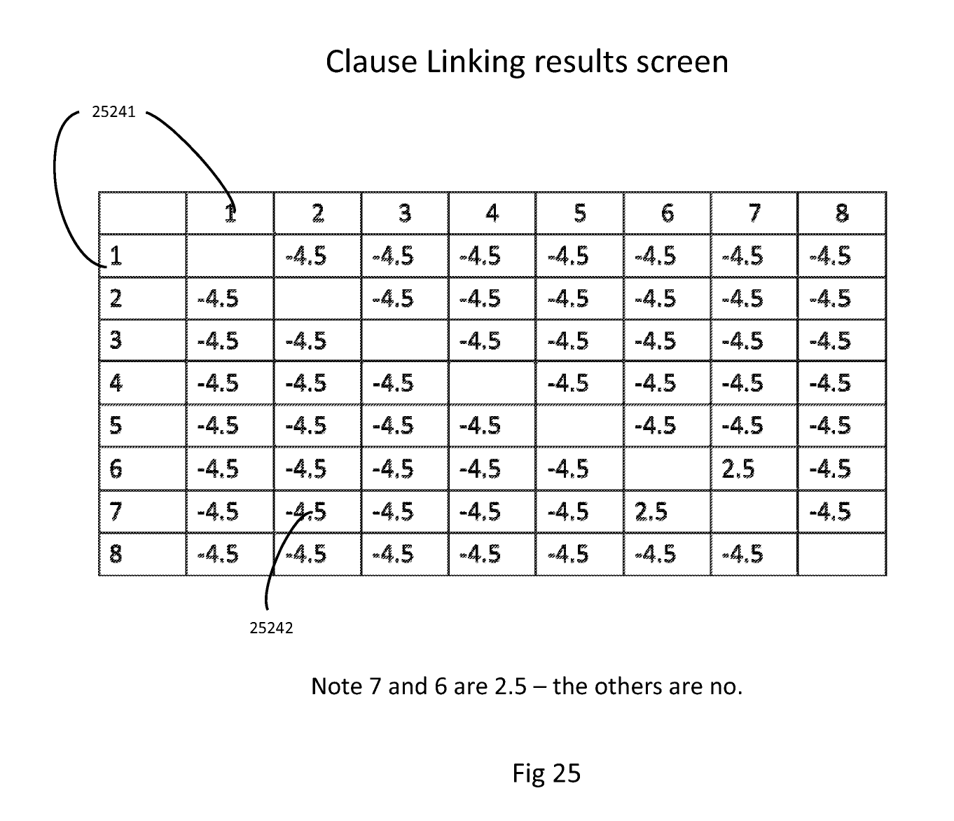

FIG. 25 illustrates a sample screen display representing the results of a hypothetical vote on linkage of clauses. These results are shown in a matrix, in which the rows and columns are labeled by clause numbers, as indicated by reference numeral 25241. The entries in each block represent the vote tally for each indicated linkage. The vote tallies are the results of the previous voting, and include the weight of each individual's vote, and the sign of the vote (either approval (+) or disapproval (−)). For example, block 25242 represents the voting to link Clauses 2 and 7, and the result (−4.5) indicates strong disagreement with the proposed linkage. In this example, the only clauses which the participants wish to link are Clauses 6 and 7, in which the tally is +2.5.

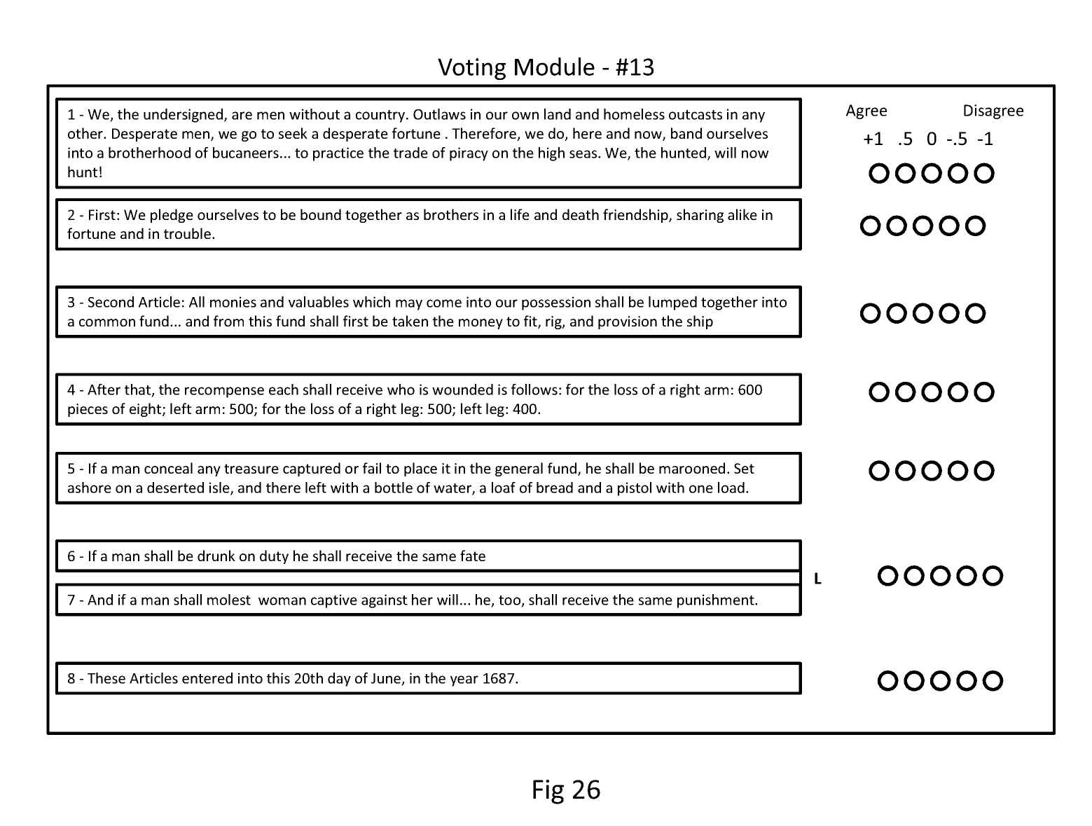

After the participants have completed their voting on whether to link various clauses, they will vote on the motion itself. FIG. 26 provides an example of a display screen for the final vote, corresponding to block 13 of FIG. 1. In FIG. 26, in accordance with the result given in the example of FIG. 25, only Clauses 6 and 7 are linked. Thus, these clauses are shown linked together in FIG. 26, and participants must vote on this pair as a unit. The participants may vote on each of the other clauses separately. The voting is weighted, as each participant may indicate the degree to which the participant agrees or disagrees with each clause.

It is preferred to include, in the software that implements the present invention, a means for building a record which fully documents the process of discussing and voting on a motion. In particular, every comment made by each participant, and every vote made by each voting participant, is preferably recorded and stored, as is every document reviewed by any participant while online, including documents opened and statements made on the forum. Thus, the system can provide a complete record showing who said what, and how each person voted on every issue.

FIG. 27 provides a schematic diagram of the system of the present invention. The system may include central server 2701 and a plurality of clients 2702. The clients in FIG. 27 are identified as “board members”, but they could be designated in other ways. Each of the blocks 2702 represents a computer which communicates with the central server.

The central server may include a programmed computer which implements most or all of the features discussed above. The central server could have the form of a plurality of identical and possibly redundant servers, which could be remotely located (i.e. in a “cloud”). In this specification, all of the above possibilities are encompassed by the term “server”.

In particular, the central server comprises a means for transmitting a proposed motion to each client. Each client includes means for displaying the proposed motion to a participant. The displaying means may be a video display.

The central server also comprises means for establishing an online discussion forum. Thus, the central server is programmed to display, to a participant, comments made by other participants, and to enable a participant to make comments.

The central server also comprises means for enabling participants to modify a motion, by presenting proposed modifications, to the participants, for display on the video displays of the various clients 2702.

The central server also comprises a means for enabling participants to vote on a motion. The server is programmed to present choices to participants, through the respective client computers 2702, and to display the results of the voting, to the participants.

The central server also comprises a means for enabling participants to break up a motion into clauses, and to vote on the manner in which the motion shall be broken up, using the methods described above.

The central server also comprises a means for comparing a set of proposed clauses with a motion from which the clauses are purportedly taken, and for notifying a participant as to whether or not the set of proposed clauses includes all elements of the motion.

The central server also comprises a means for enabling participants to discuss online the manner in which a motion shall be broken up into clauses.

The central server may be programmed so that it comprises a means for enabling participants to vote upon complete sets of proposed arrangements of the motion into clauses. Alternatively, the central server may be programmed to comprise means for enabling participants to vote upon particular clauses without regard to which proposed set contains a particular clause.

The central server also comprises a means for enabling participants to link two or more clauses together.

The central server also comprises a means for establishing rules of participation, wherein such rules include at least one of a) who may participate in an online discussion and a manner of such participation, b) who is permitted to vote, and c) the weight accorded to each participant's vote.

The functions attributed to the central server, discussed in the preceding paragraphs, may be distributed among the various computers in the system. There may be more than one server, and one or more of the client computers could be programmed to perform some or all of the tasks described with respect to the central server.

In general, the various clients 2702 are positioned in different geographical locations. But it is also possible that some or all of the clients can be located in or about the same place, within the scope of the invention. The connections between the central server and the various clients can be established through the Internet, or through a private network, by direct wired connections, or by wireless transmission.

The invention can be modified in various ways, which will be apparent to the reader skilled in the art. Such modifications should be considered within the spirit and scope of the following claims.

What is claimed is:

1. A system for enabling a plurality of participants to review and decide upon a motion, comprising:
a) a central server, the server comprising a programmed computer,
b) a plurality of clients, each client comprising a computer which is connected to communicate with the central server,
c) wherein the central server comprises means for transmitting a proposed motion to each client, wherein each client includes means for displaying the proposed motion to a participant,
d) wherein the central server comprises means for establishing an online discussion forum, wherein each client includes means for displaying, to a participant, comments made by other participants, and for enabling a participant to make comments,
e) wherein the central server comprises means for enabling participants to modify a motion, by presenting proposed modifications to participants through respective clients, and
f) wherein the central server comprises means for enabling participants to vote on a motion, by presenting choices to participants through respective clients, and for displaying results of voting to participants.

2. The system of claim 1, wherein the central server comprises means for enabling participants to break up a motion into clauses, and to vote on a manner in which the motion shall be broken up.

3. The system of claim 1, wherein the central server comprises means for enabling participants to propose new clauses to the motion, wherein said new clauses were not part of the motion as originally proposed.

4. The system of claim 2, wherein the central server comprises means for comparing a set of proposed clauses with a motion from which the clauses are purportedly taken, and for notifying a participant as to whether or not the set of proposed clauses includes all elements of the motion.

5. The system of claim 1, wherein the central server comprises means for enabling participants to discuss online a manner in which a motion shall be broken up into clauses.

6. The system of claim 5, wherein the central server comprises means for enabling participants to vote upon complete sets of proposed arrangements of the motion into clauses.

7. The system of claim 5, wherein the central server comprises means for enabling participants to vote upon particular clauses without regard to which proposed set contains a particular clause.

8. The system of claim 5, wherein the central server comprises means for enabling participants to link two or more clauses together.

9. The system of claim 1, wherein the central server comprises means for establishing rules of participation, wherein said rules include at least one of a) who may participate in an online discussion and a manner of such participation, b) who is permitted to vote, and c) a weight accorded to each participant's vote.

10. A system for enabling a plurality of geographically disparate participants to review, and vote upon, a motion, comprising:
a central server connected to a plurality of clients, the server and clients comprising programmed computers, the clients being associated with participants,
the server being programmed to display, on the clients, a motion under consideration,
the server being programmed to provide an online discussion forum wherein participants can enter comments and questions about a motion,
the server being programmed to establish rules of participation, wherein said rules determine which participant may vote and a weight accorded to each participant's vote,
the server being programmed to enable participants to vote on the motion, according to said rules of participation.

11. A method for enabling a plurality of geographically disparate participants to review and decide upon a motion, comprising:
a) displaying a proposed motion to a plurality of participants by transmitting the motion to distinct computers associated with said participants and showing the motion on each of said computers,
b) accepting comments and questions from participants, regarding the motion, and displaying comments and questions from one participant to at least one other participant,
c) receiving suggestions, from participants, regarding proposed modifications to the motion, said suggestions being entered by participants on their respective computers, and
d) conducting an online vote among participants, regarding the motion, and displaying results of said vote to said participants.

12. The method of claim 11, further comprising accepting proposals from participants for breaking up a motion into clauses, and conducting an online vote on a manner in which the motion shall be broken up.

13. The method of claim 12, further comprising comparing a proposed arrangement of a motion as a set of clauses, with an original motion, and indicating to participants whether the set of clauses includes all elements of the motion.

14. The method of claim 12, further comprising accepting a question or comment, entered by at least one participant through said participant's computer, regarding a manner of proposed break-up of a motion into clauses, and displaying said comment or question to at least one other participant.

15. The method of claim 14, further comprising conducting an online vote among participants regarding complete sets of proposed arrangements of the motion into clauses.

16. The method of claim 14, further comprising conducting an online vote among participants on particular clauses without regard to which proposed set contains a particular clause.

17. The method of claim 12, further comprising receiving a proposal, from at least one participant, for linking two or more clauses together.

18. The method of claim 11, wherein step (a) is preceded by establishing rules of participation for consideration of the motion, wherein said rules include at least one of a) who may participate in an online discussion and a manner of such participation, b) who is permitted to vote, and c) a weight accorded to each participant's vote.

19. A method for enabling a plurality of geographically disparate participants to review, and vote upon, a motion, comprising:
displaying, to each of a plurality of geographically disparate participants, a proposed motion, the displaying being accomplished by showing the motion on a plurality of computers, each computer being associated with a respective participant,
accepting comments and/or questions from participants regarding the motion, and displaying said comments and/or questions to other participants, and
conducting an online vote among participants regarding the motion.

20. The method of claim 19, further comprising establishing rules of participation, wherein said rules determine which participant may vote and a weight accorded to each participant's vote.
